(19) United States
(12) Patent Application Publication
(10) Pub. No.: US 2003/0036942 A1
(43) Pub. Date: Feb. 20, 2003

(54) Project evaluation template

(76) Inventor: James M. Wescott, Montclair, NJ (US)

Correspondence Address: DARBY & DARBY P.C., P. O. BOX 5257, NEW YORK, NY, 10150-5257, US

(21) Appl. No.: 10/177,641

(22) Filed: Jun. 20, 2002

Related U.S. Application Data
(60) Provisional application No. 60/299,958, filed on Jun. 21, 2001.

(51) Int. Cl. G06F 17/60

(52) U.S. Cl. 705/9

(57) ABSTRACT

A system for controlling and evaluating a regulatory submission project seeking approval of the sale of an item. A set of templates defining milestones and times based on qualitative assessments of the item are established in a computer. A relative quantitative value of completing a milestone is then established. Information is entered into a database about past and ongoing evaluations of the item, including tests performed on the item. A determination is made as to whether a milestone has been achieved on time. If a milestone has not been achieved on time, the relative loss in value to the sales of the item based on the relative quantitative value of completing the milestone is calculated. The status of the evaluation is then reported.

### CROSS-REFERENCE TO RELATED APPLICATIONS

This application claims the priority of U.S. Provisional Application No. 60/299,958, filed on Jun. 21, 2001, which is hereby incorporated hereby by reference in its entirety.

### BACKGROUND OF THE INVENTION

The present invention is directed to a system and method for evaluating regulatory submission projects and, more particularly, to computer software applications and databases that facilitate the evaluation of regulatory submission projects.

Before a new drug product can be approved for sale to the public, regulatory agencies require proof that the product is safe for use and effective in treating some condition. To establish this, drug companies conduct tests of the drug. These tests may involve giving the drug to animals and measuring the result. Where the drug is intended for humans, a final or late phase in the testing process is the conducting of clinical trials in which the drug is administered to humans and the results are measured.

Throughout the conduction of these tests information must be collected from various groups and individuals, and the progress of the testing monitored. Reports must be produced to enable management to make and support decisions regarding whether to continue the project through the regulatory submission process.

### SUMMARY OF THE INVENTION

The present invention is directed to a software system that provides a management tool for qualitatively evaluating the development of regulatory submission projects using templates. The templates capture information about projects (i.e. regulatory submissions), and are updated throughout project development.

The system provides two different templates: one for Early Phase testing and development, designed to capture information about a project up to the first experience in man, and one for Late Phase testing and development. The templates provide a consistent and reliable way to capture critical information across all regulatory submission projects. Information captured by the templates facilitates the production of reports to evaluate regulatory submission projects and support management decisions regarding the planning of clinical studies, regulatory submissions, market projections and resource allocations. The system increases management's control by providing them with early warning of trends involving project milestones, deadlines, costs and resources. As a result, management can take necessary actions to ensure a project remains meaningful to the company.

The system is browser-based, thereby allowing hundreds of employees at all levels of the company to create reports, and see the impact of changes in status as projects are suspended, ended or modified based on evolving strategic goals. The system provides users throughout a company—including project planners, project managers and management—with the ability to view and analyze the projects and make better decisions about project priorities, resource availability and project cost performance. Managers can project the likelihood of success for each stage of the project, assign a level of risk/reward, and measure the impact of any changes in project status.

Moreover, the system allows different users within the organization to view different updates or versions of the templates and/or only selected fields, based on user-configurable business rules and thresholds, ensuring that each accountable staff member gets the desired information. For instance, a project manager might need project information across business areas or only on the projects assigned to him/her. Further, executives outside of the traditional project manager role can easily drill down into hierarchies and view summaries of projects, e.g., the project over time, by therapy team, across drug indication and by indication. These features enable organizations to significantly reduce the time and expense associated with searching through weekly project reports, thereby improving project efficiency.

Further, the database of the system provides the identification of the user who made each change, thereby permitting managers when necessary to obtain explanations of entered data.

### BRIEF DESCRIPTION OF THE DRAWINGS

The foregoing and other features of the present invention will be more readily apparent from the following detailed description and drawings of an illustrative embodiment of the invention in which:

FIG. 1 is an overview of the system of the present invention;

FIG. 2 is a block diagram of the hardware used to implement an embodiment of the present invention;

FIG. 3 is a basic diagram of the system architecture used to implement an embodiment of the present invention;

FIG. 4 is a more detailed diagram of the system architecture shown in FIG. 3;

FIG. 5 is a diagram of the middleware portion of the system architecture shown in FIG. 3;

FIG. 6 is a diagram of the function processes of the PET system;

FIG. 7 is a swimlane process diagram illustrating the process for creating a PET user account;

FIG. 8 is a swimlane process diagram illustrating the process for terminating a PET user account;

FIG. 9 is a swimlane process diagram illustrating the process for modifying a PET user account;

FIG. 10 shows a use case or sequence diagram for illustrating the process for authorizing access (authentication) to a PET application;

FIG. 11 shows a swimlane diagram illustrating the process for accessing a PET user account;

FIG. 12 shows a swimlane diagram illustrating the process for creating a template ;

FIG. 13 shows a swimlane diagram illustrating the process of the MTS validation;

FIG. 14 shows a swimlane diagram illustrating the process for error-checking;

FIG. 15 shows a swimlane diagram illustrating the process for editing a template;

FIG. 16 shows a swimlane diagram illustrating the process for creating a management report;

FIG. 17 shows t he Project Tab of the Project screen;

FIG. 18 shows a page of the Reports Tab of the Project screen;

FIG. 19 shows another page of the Reports Tab of the Project Screen;

FIG. 20 shows a screen shot of an example of a Data Validation Report;

FIGS. 21(a) and 21(b) show an example of a printout of a Data Validation Report

FIGS. 22 and 23 show the Value Based Milestones Report Tab;

FIG. 24 shows a screen shot of an example of a Value Based Milestones Report;

FIGS. 25(a) through 25(c) show a printout of an example of a Value Based Milestones Report;

FIGS. 26 and 27 show the Submission Due Report Tab;

FIG. 28 shows a screen shot of an example of a Submission Due Report;

FIG. 29 shows a printout of an example of a Submission Due Report;

FIGS. 30-32 show the Ad Hoc Report Tab;

FIG. 33 shows a screen shot of an example of an Ad Hoc Report;

FIG. 34 shows a printout of an example of an Ad Hoc Report;

FIGS. 35(a) and 35(b) show an example of the two-page Electronic Template Report;

FIGS. 36(a) through 36(c) show an example of the three-page Electronic Template Report;

FIGS. 37 and 38 show the Early Phase template;

FIG. 39 shows the Early Phase Issues screen;

FIG. 40 shows the Unmet Medical Needs Tab of the Issues screen;

FIG. 41 shows the Exclusivity Tab of the Issues screen;

FIG. 42 shows the Time Tab of the Issues screen;

FIG. 43 shows the Timelines Tab;

FIG. 44 shows the Estimates Tab;

FIGS. 45 and 46 shows the Late Phase template;

FIG. 47 shows the Drivers of Value Tab;

FIG. 48 shows the Drivers of Uncertainty Tab;

FIG. 49 shows the Regulatory Issues Tab;

FIG. 50 shows Manufacturing Issues Tab;

FIG. 51 shows the Costs Estimates Tab;

FIG. 52 shows the Sales Forecasts Estimates Tab;

FIG. 53 shows the Pricing Issues and Assumptions Estimates Tab;

FIG. 54 shows the Later Indications Estimates Tab; and

FIG. 55 shows the Create New Template Tab.

FIG. 56 shows the logon screen.

FIG. 57 shows the Edit Template Tab.

FIG. 58 shows the home page.

### DESCRIPTION OF AN ILLUSTRATIVE EMBODIMENT

The system of the present invention provides an information management tool that evaluates regulatory submission projects to ensure that the projects with the most potential for success are done and done successfully. The system, which is sometimes referred to as the Project Evaluation Template (PET), breaks down a regulatory submission project into weighted and categorized Milestones including Stop Rules, described further below. Each project is assigned at least one Driver of Value, which is a property that determines the ultimate value of the product to the company, e.g., cost, effectiveness and/or safety compared to current treatments. Time to market may be another Driver of Value. Each Driver of Value must have at least one associated Milestone. These Milestones can be reviewed in conjunction with the project's progress to ensure the business objectives, which may change during the life of the project, are being met.

“Drivers of Value” is a United States service mark registered to Cambridge Pharma Consultancy, Ltd. of the United Kingdom.

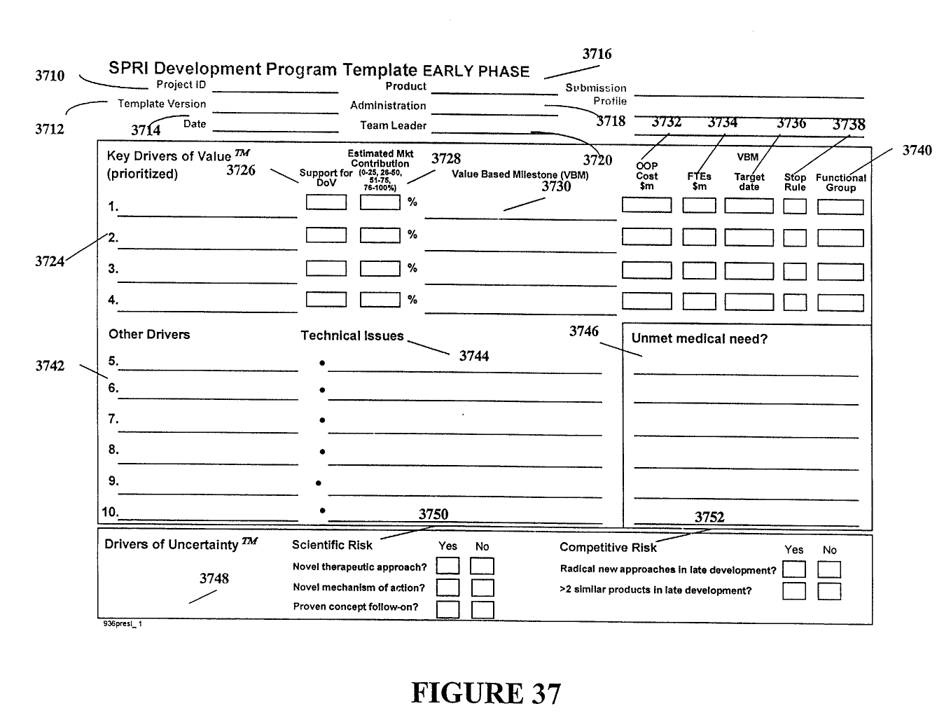

Templates are used by planners as a “scratch pad” for entering data, and include Early and Late Phase templates. These templates, examples of which are shown in FIGS. 37, 38, 45 and 46, provide a consistent way to capture critical information across all regulatory submission projects. Information captured by the templates facilitates the planning of clinical studies, regulatory submissions, market projections and resource allocations. Each template also provides information on dates for achieving milestones. It should be clear that the templates disclosed herein serve merely as examples. The fields and layout may be modified and still achieve the objectives of the system as described herein.

A typical regulatory submission process includes three phases. Phase I is the safety assessment phase first involving volunteers (Phase IA) and then actual diseased patients (Phase IB). Phase II is a transition phase to establish dose and dose regimen, again first involving volunteers (Phase IIA) and then actual diseased patients (Phase IIB). Phase III is the registration phase involving pivotal studies, e.g., clinical trials. Finally the drug developer submits a new drug application (NDA) to the FDA for approval.

The Early Phase template can evaluate projects through preclinical studies and up to Phase I and early Phase II trials (through Pharmacologic Proof of Concept). Projects that are typically in Phase IIB and III trials are better suited to the Late Phase template. However, planners have the flexibility to determine the transition point.

### 1. Software Overview

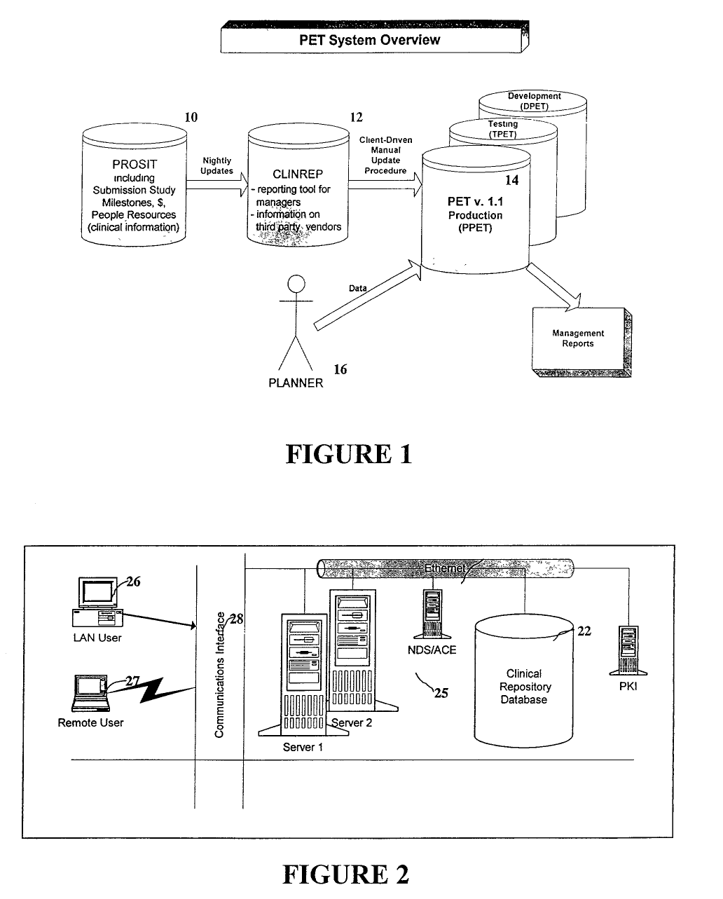

FIG. 1 shows a software overview of the system. There are two sources of information for inclusion in the PET system 14. Some information, such as submission number, may be posted from PROSIT 10 through CLINREP 12. PROSIT 10 is clinical trial management software developed by Schering-Plough and is described in U.S. Patent application No. 09/655,667, entitled “Clinical Trial Management System,” filed Sep. 6, 2000, which is incorporated herein by reference. CLINREP 12 is a clinical data repository used as a reporting tool for managers and which retains information on third party vendors. The information in CLINREP is used to update the PET (Project Evaluation Template) 14 during development (DPET), then testing (TPET), and finally during the production stage (PPET). The DPET and TPET stages are used to create updated versions of the PET system, whereas the PPET stage represents version in current use. Additional data is input to the PET 10 by the project planner 16.

### 2. Hardware Arrangement

FIG. 2 shows an example of a hardware arrangement for carrying out an embodiment of the present invention. The arrangement consists of server(s) 20, 21, a clinical repository database 22 (hereinafter “database”) , and possibly PKI (Public Key Infrastructure) 23 and/or NDS/ACE 25 (Novell Directory Service/American Council on Education), communicating with one another over, for example, an ethernet 24. A LAN user computer 26 or remote user personal computer 27 communicates with the ethernet 24 via a communications interface 28, such as a LAN, NTLink, IPLink, or some other suitable interface.

The personal computer may be, for example, a Dell GXa with 64 MB RAM, having a Schering-Plough Research Institute Operating System (SPRIOS) build with Internet Explorer 4.01 Service Pack 1 and Microsoft's Internet Explorer 5.0 or higher. The server(s) may be, for example, a Compaq Proliant 6400 with 2G RAM, loaded with, for example, Oracle 8.15, Site Server 3.0, Microsoft Office 97 SR2 (Word, Excel & Access NT Option pack 4.0), Microsoft Internet Information Server 4.0, Microsoft Transaction Server (MTS) 2.0, SMTP Server, Index Server, Oracle 8.17, and Oracle Client 8.17 (a DLL file loaded on a client's machine to provide server access), Visual Studio Enterprise (VB, Interdev & Source Safe), Front Page 98 Extensions, Adobe Acrobat 4.05 Reader, NT Service Pack 6a, Microsoft Data Access Components (MDAC) 2.1 Service Pack 2, Active Directory Service Interfaces (ADSI) 2.5, Visual Studio 6.0 Service Pack 3, and Site Server Service Pack 3. MTS handles transactions that ensure that all database operations are consistent, durable and atomic.

Except where noted, the above-mentioned hardware and software are well-known, off-the-shelf items and do not form a part of the inventive concept of this invention. Detailed descriptions of these elements are therefore omitted. It should be noted that other hardware and software, as appreciated by those skilled in the art, could instead be used without departing form the spirit and scope of the invention.

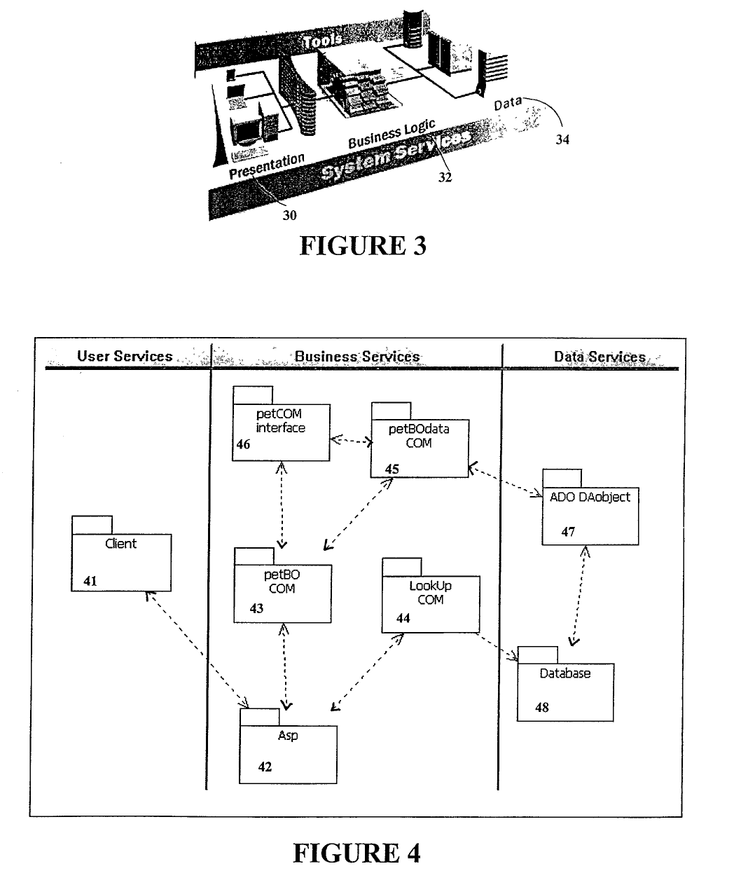

The system architecture is a three-tier model in which functionality is segmented into three logical tiers: presentation services (end user) 30, business services (middleware) 32, and data services 34, as shown in FIG. 3. As explained in more detailed below, the first tier presents data to the user, the second is formed by COM components that provide database access, and the third tier is a database, such as one provided by Oracle.

The presentation, or end user, tier 30 is responsible for gathering information from the user, sending the user information to the business services tier 32 for processing, receiving the results of the business services tier processing, and presenting those results to the user. The presentation tier output should be compatible with the browser being used, e.g., Microsoft's 4.01 browser.

The business services tier, or middleware 32, is responsible for receiving input from the presentation tier, interacting with the data services tier 34 to perform business operations, and sending processed results to the presentation tier 30. This tier 32 functions as a translation layer which allows communication between the “front-end” or user and the clinical repository database located in the data services tier.

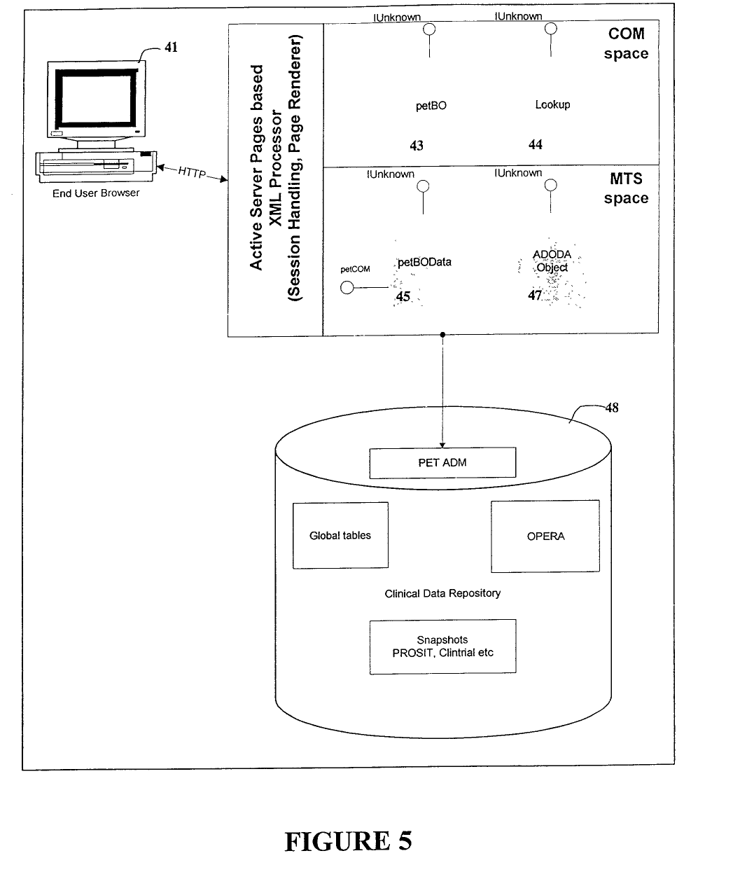

The logical design of the business services tier or middleware is shown in FIGS. 4 and 5. The application is web-based, so not much of the application needs to be located on the client side. Such a configuration is advantageous in that there is less start-up time or financial investment needed when acquiring a new client.

Referring to FIG. 4, a user 41 can login into the PET application using an Internet Browser (i.e., user services) from a desktop. When a project template is created/modified/deleted, the browser accesses the Active Server Pages (ASP files 42) located on an NT server (i.e., business services layer). The Active Server Pages will call the Visual Basic dynamic linked libraries (i.e., petBO COM 43, LookUp COM 44, petBOdata COM 45) using a component object model interface type library (i.e., petCOM interface 46). The visual basic dynamic linked libraries LookUp COM 44 and petBO COM 43 will retrieve and/or update data sent from the browser (i.e., user services) in the Oracle database 48 running on a UNIX server, using Active Dataobject library (ADO DAobject) 47.

FIG. 5 shows a different view of the subject matter of FIG. 4. That is, illustrates much of the same details as FIG. 4, except for the following. The Microsoft Active Server pages uses XML processor (session handling and page renderer) services to make a request and respond thereto. The Visual Basic dynamic linked libraries petBOData COM 45 and Active Data access objects(ADODA Object) 47 are deployed under Microsoft Transaction server(MTS Space) to utilize the transaction commit or roll back functionalities. The commit function makes permanent the changes made during an update to the database, and the rollback function reverses changes made during an update. PetBO COM 43 and Lookup COM 44 perform business services using Component Object Model in COM space. FIG. 5 also shows that PET application database sources data from other applications such as Global tables, OPERA and PROSIT through a centralized repository called Clinical Data Repository The business services components are based on, for example, Microsoft DNA architecture, running on Microsoft Windows NT 4.0, for example. The component containers used are, for example, Internet Information Server 4.0, Microsoft Transaction Server 2.0, and Microsoft Site Server 3.0 Again, this software is well-known and off-the-shelf, and thus detailed descriptions are omitted. Other software could instead be used without departing form the spirit and scope of the invention.

The use of the business services tier provides application autonomy, scalability and reliability. Autonomy refers to the application's ability to govern its critical resources, like connection pooling, transaction processing, etc. Scalability refers to the application's ability to support anywhere from ten users to thousands of users, by simply adding or subtracting resources as necessary to “scale” the application. Reliability refers to the application's ability to provide accurate, valid results.

The data services tier is responsible for storage, retrieval, maintenance and integrity of the data, and may be built on Oracle 8i database, for example. The data architecture is fed from the central repository, which allows data to be sourced from PROSIT, which manages clinical trials, and OPERA (Operational Planning Enterprise and Analysis), which performs internal tracking of manpower and resources.

### 3. Functional Processes

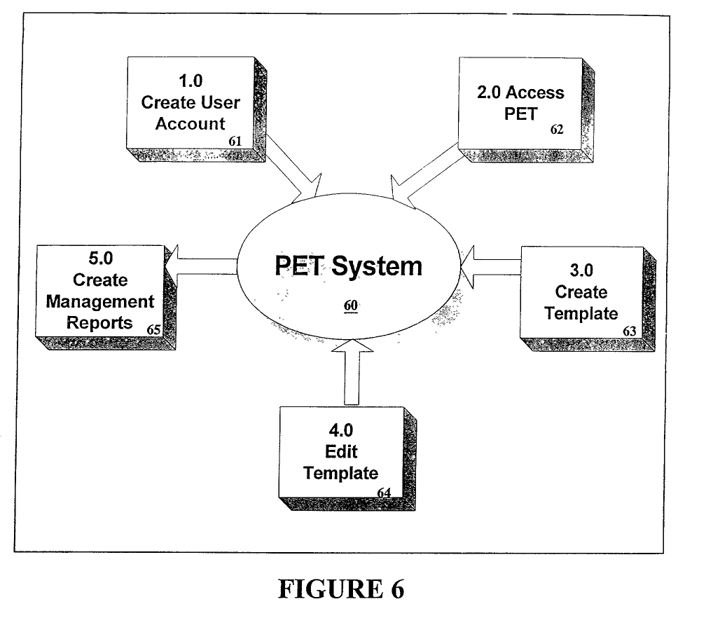

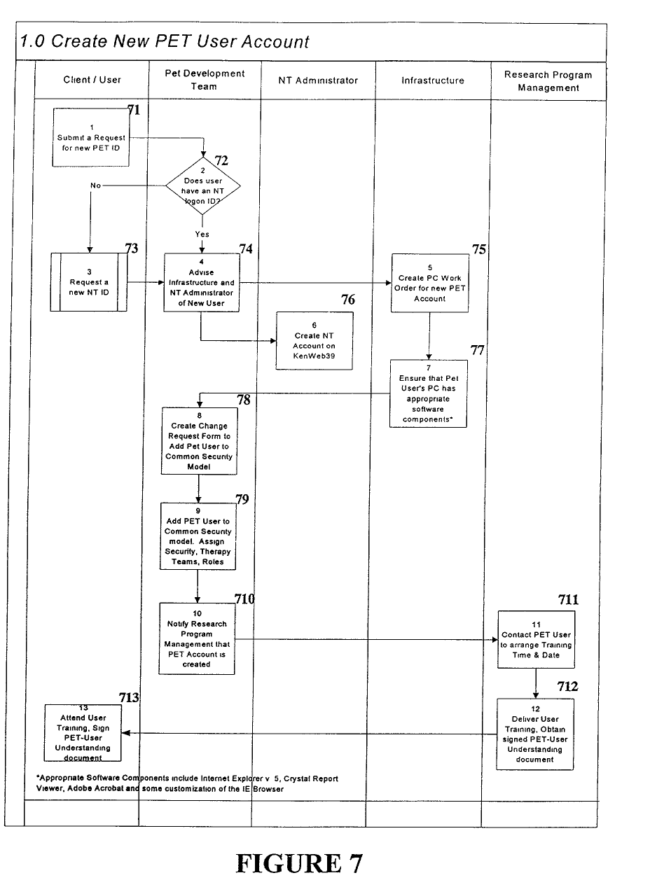

FIG. 6 illustrates the five major functional models of the system 60: (1) create user accounts 61; (2) access PET 62; (3) create templates 63; (4) edit templates 64; and (5) create management reports 65. These five functional modules are illustrated in FIGS. 7-16 using a sequence diagram and swimlane process diagrams, which reflect the architectural tiers (described above) that perform the work for each of the modules.

### 3a. Create/Terminate/Modify PET User Account Modules

### 3ai. Create PET User Account Module

FIG. 7 shows the swimlane process diagram illustrating the process for creating a PET user account. A user first submits a request for a new PET identification (ID) (step 71). The system administration determines whether or not the user already has an NT login ID (step 72). If not, the user must request a new NT ID (step 73). In either case, the system administration advises the infrastructure and NT administrator that there is a new user (step 74). The NT administrator creates an NT account in the user database, KenWeb39 (Schering-Plough's Kenilworth Webserver#39, which is an NT server used for production processing) (step 76). Also, Schering-Plough's infrastructure creates a PC work order for a new PET account (step 75) and ensures that the PET user's computer has the appropriate software components, which may include, for example, Microsoft's Internet Explorer browser, Crystal Report Viewer, and Adobe Acrobat, which are well-known, off-the-shelf software products, and possibly some customization of the browser (step 77).

The PET system administration then creates a change request form to add the PET user to the Common Security Model (CSM, described in the “Security” section below) (step 78), and then adds the PET user to the Common Security Model, assigning the user a level of security, therapy teams and roles (step 79). The system administration also notifies the research program management that a PET account was created (step 710). The research program management contacts the PET user to arrange for a training time and date (step 711). Management then delivers the training and obtains from the user a signed PET user understanding document (steps 712 and 713).

### 3aii. Terminate PET User Account Module

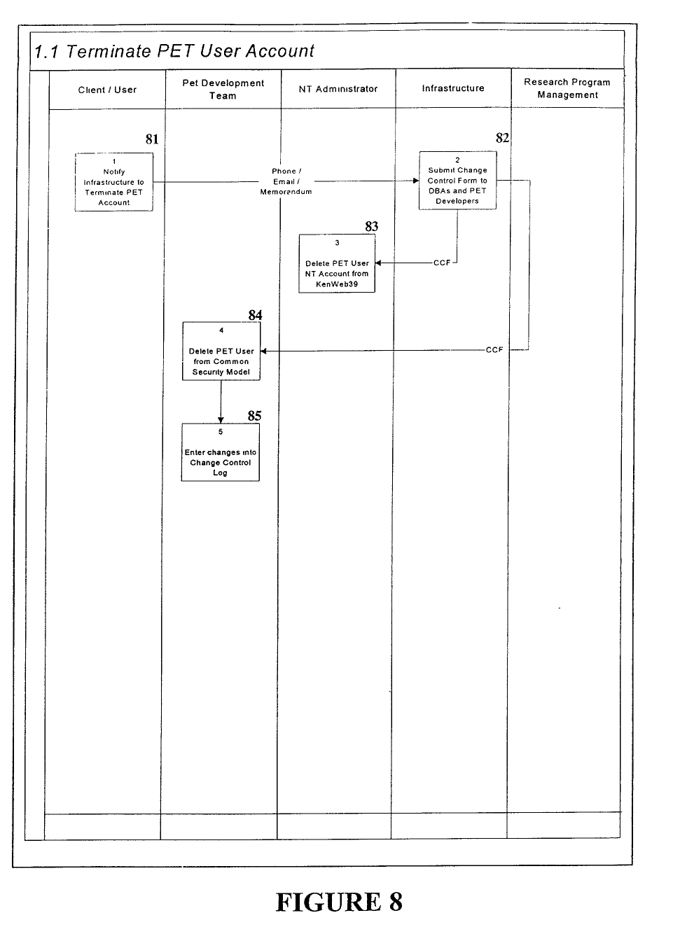

FIG. 8 shows the swimlane process diagram illustrating the process for terminating a PET user account. First the user requests, by phone, e-mail or memorandum, the infrastructure to terminate the PET account (step 81). The infrastructure then submits a change control form to the databases and PET system administration (step 82). The NT administrator deletes the PET user NT account from KenWeb39 server (step 83), and the PET system administration deletes the PET user from the Common Security Model (step 84). Finally, the PET Development team enters the change into a change control log (step 85). Note that in the figure “CCF” stands for Change Control Form.

### 3aiii. Modify PET User Account Module

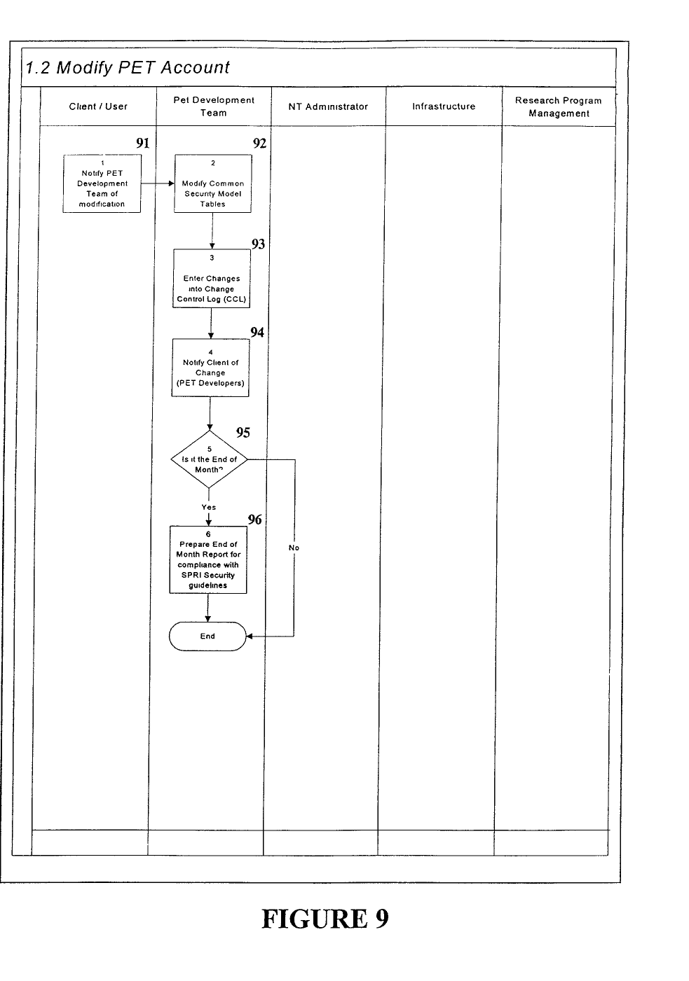

FIG. 9 shows the swimlane process diagram illustrating the process for modifying a PET user account. First the user notifies the PET system administration of the modification (step 91). The PET development team then modifies the Common Security Model tables (step 92), enters the changes into the change control log (step 93), and notifies the user of the change (step 94). At the end of the month (step 95), the PET development team, if required by company guidelines, prepares an end-of-month report (step 96).

### 3b. Authenticate User and Access PET Module

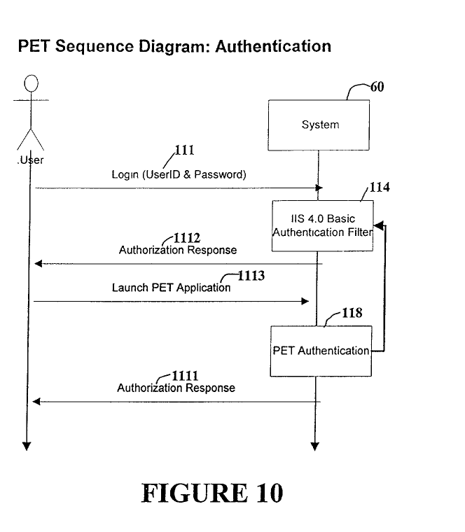

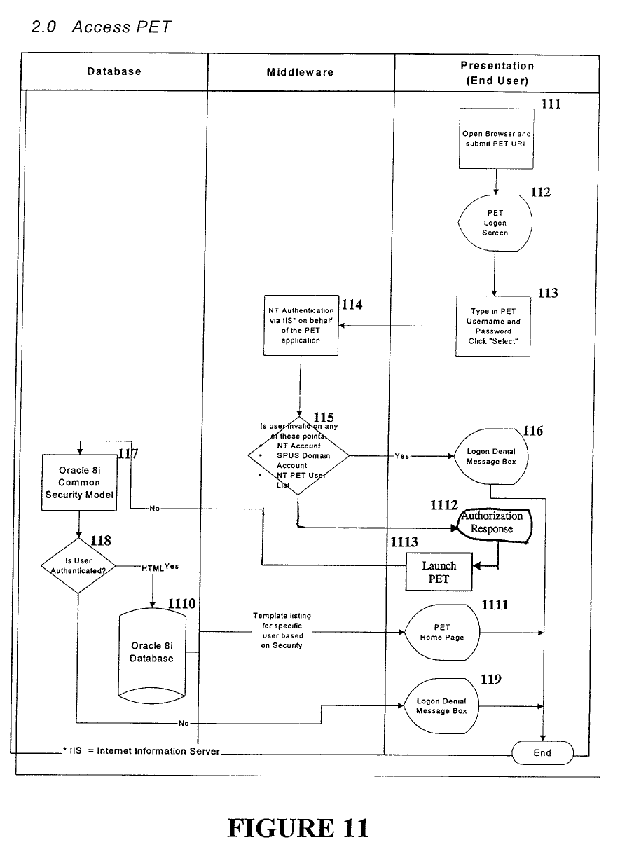

FIG. 10 shows a use case diagram for illustrating the process for authorizing access to a PET application, and FIG. 11 shows a swimlane diagram illustrating the process for accessing the PET system. Access to the PET system assumes that the user has authorized access (discussed below in the “Security” section) and a correct desktop configuration.

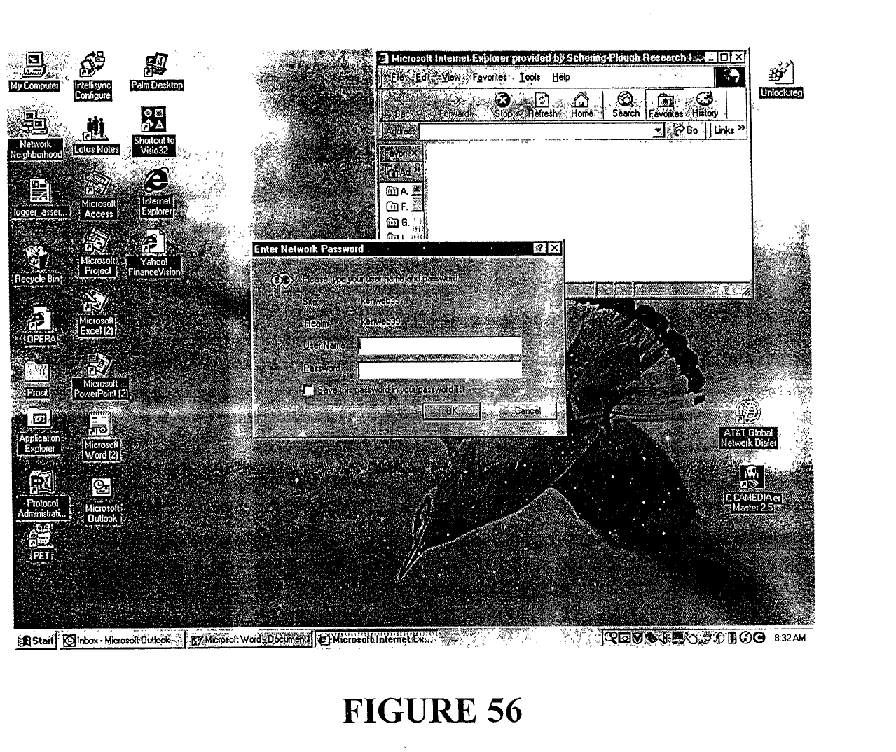

First the user opens the browser and submits the PET URL (step 111). The PET logon screen, which is shown in FIG. 56, appears (step 112), and the user enters logon information, that is, a username and password (step 113).

The middleware portion of the system then uses the Microsoft Internet Information Server 4.0 basic authentication filter to confirm the validity of the entered username and password (step 114), and determines whether the user is invalid based on any one of its NT account, company domain account, and the NT PET user list (step 115). If the user is invalid on any of these points, a logon denial message is displayed (step 116).

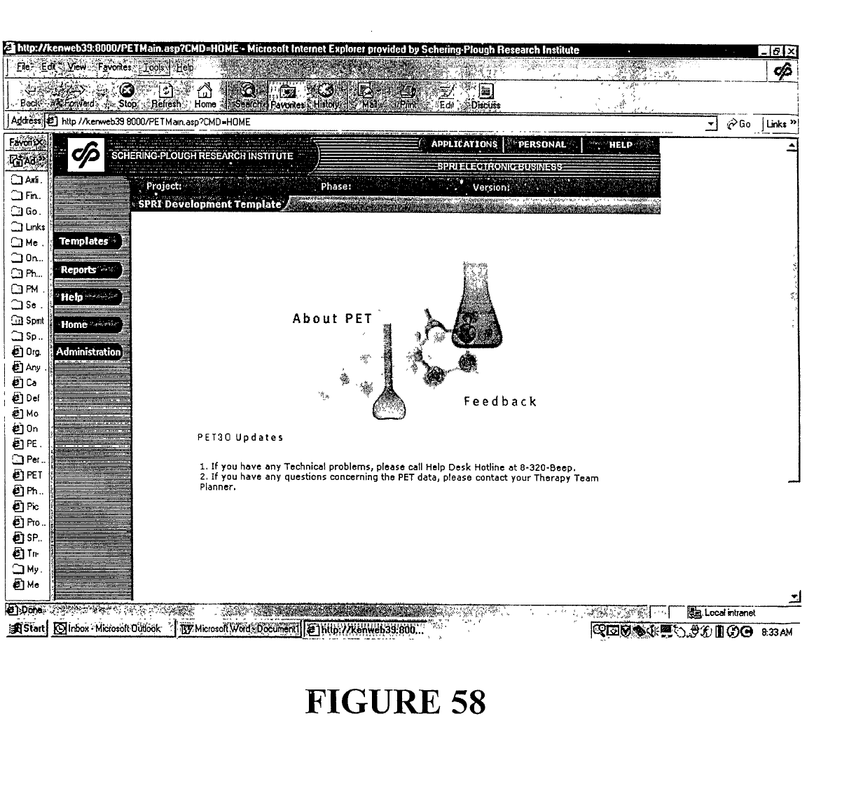

Assuming the user is not invalid on any of the above-noted points (i.e., validity is confirmed), the system transmits to the user an authorization response (step 1112). The user then launches the PET application (step 1113), and the system subsequently uses the Common Security Model (step 117) to authenticate the PET user (steps 117 and 118). If the user is not authenticated, a logon denial message is displayed to the user (step 119). Otherwise the clinical repository database (shown in FIG. 2) is used (step 1110) to provide a template listing for the specific user in accordance with the user's security clearance level, and the PET homepage, as shown in FIG. 58, is displayed. (Step 1111).

### 3c. Create Template Module

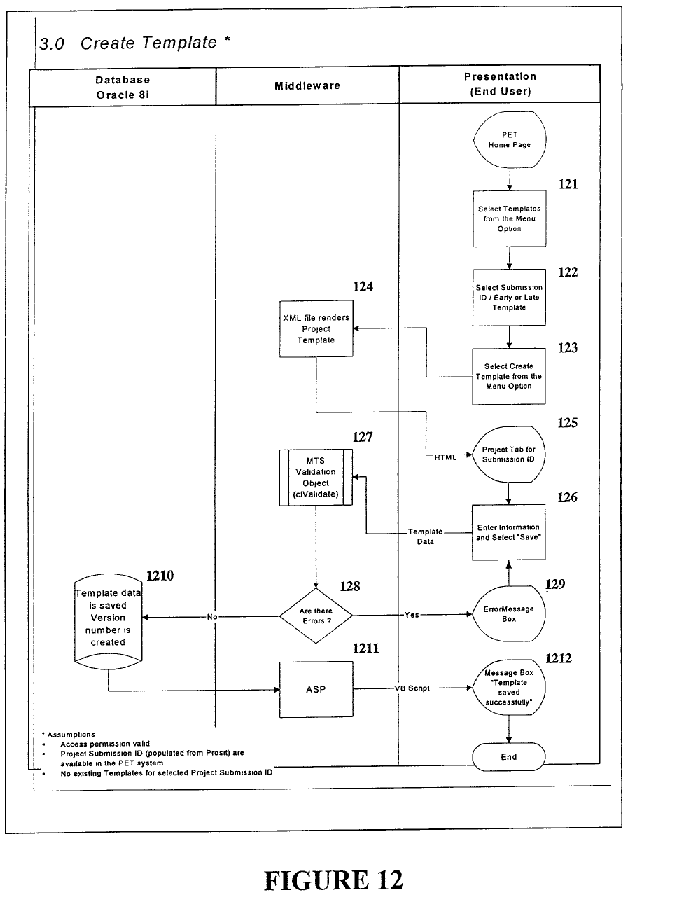

FIG. 12 shows the swimlane process diagram illustrating the process for creating either an Early or Late Phase template. A template may be created assuming there is a clinical trial project that has been assigned an ID, but has no pre-existing templates in the system. Templates provide a consistent and reliable way to capture critical information across all regulatory submission projects. The Early Phase template is designed to capture information about a project up to the first experience in humans, and the Late Phase template captures information thereafter.

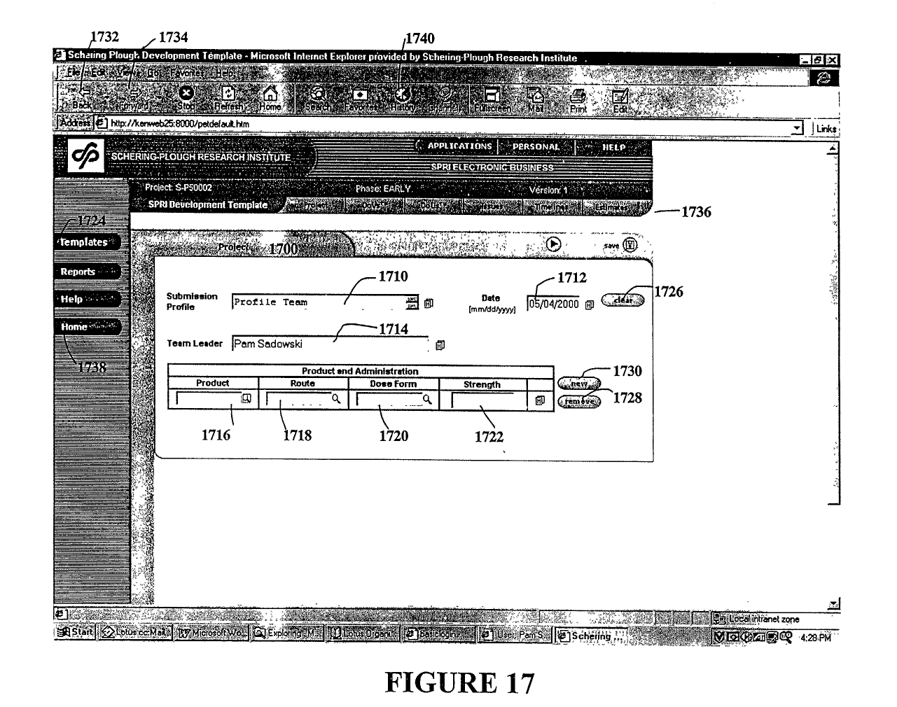

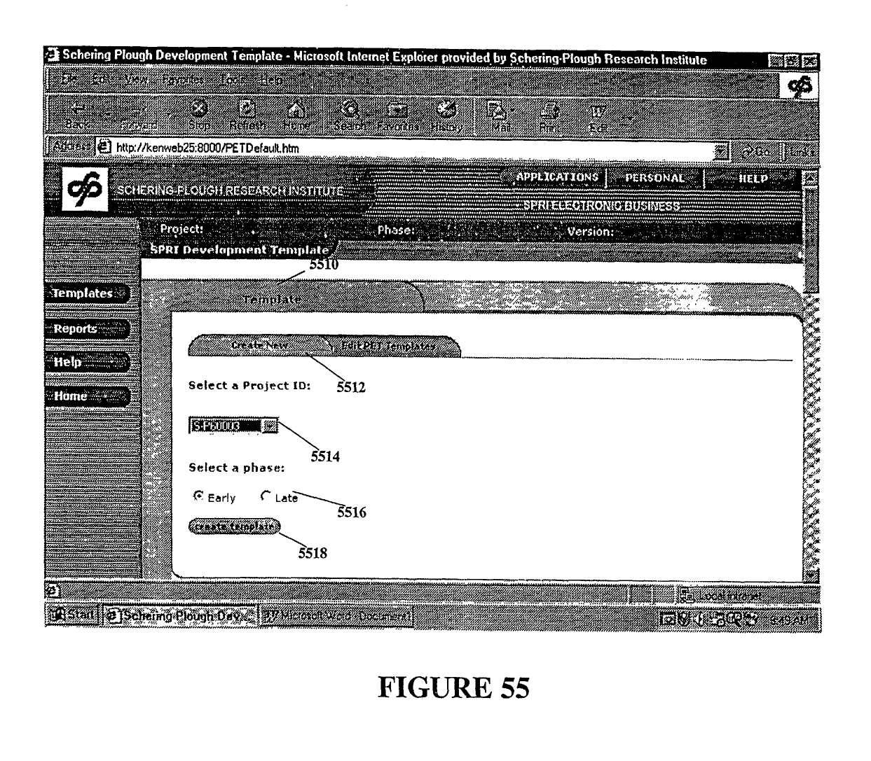

The user first selects “Templates” from the menu options (step 121). At the Template tab 5510, the user selects the Create New tab 5512, a screen shot of which is shown in FIG. 55. The user selects a submission ID from drop-down menu 5514 and picks either an Early or Late Phase template (step 122) by selecting one of the buttons 5516. The details of Early and Late Phase templates are described in the “Templates” section below. After the user actuates the “Create Template” button 5518 (step 123), the middleware portion of the architecture provides in XML format the project tab (steps 124 and 125), shown in FIG. 17.

The project tab 1700, a screen shot of which is shown in FIG. 17, displays general information fields about the project submission, including the submission profile 1710, date 1712, team leader 1714, product 1716, route 1718, dose form 1720 and strength 1722, the last four of which contain a lookup capability. The “route” refers to how the product is administered, i.e., orally, intravenously, etc. The user enters information into the fields and then saves the information (step 126).

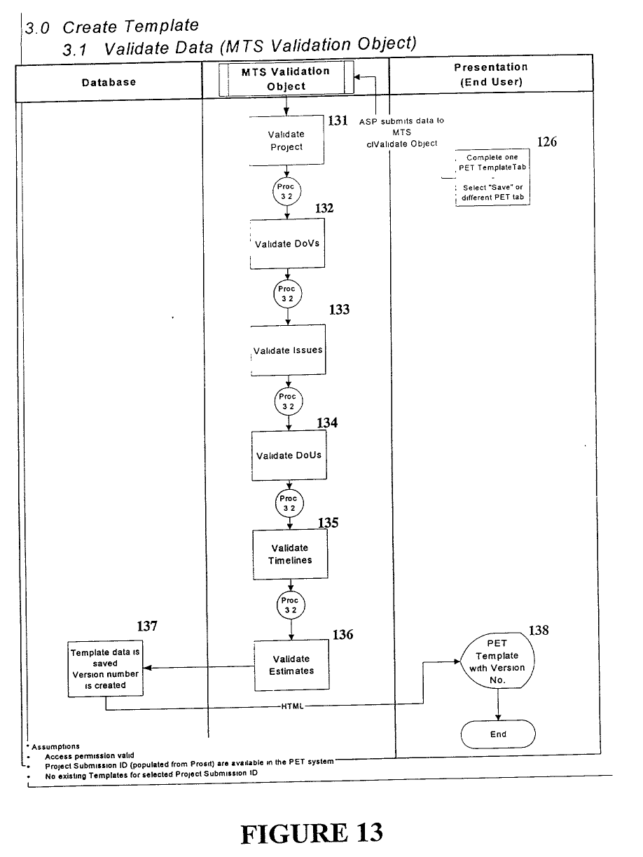

As shown in FIG. 12, the template data is then validated using Microsoft Transaction Server (MTS) validation object (step 127), which is described below with respect to FIG. 13, and it is determined whether there are any errors (step 128). If there is an error, an error message box is displayed to the user (step 129), and the user is again prompted to enter the project submission information (step 126). If there are no errors, on the other hand, the template data is saved by being processed into XML format and sent to the database (step 1210). This step also creates a version number. Finally, the Active Server Page (ASP) is invoked (step 1211) to display to the user a message indicating that the template was saved successfully (step 1212).

FIG. 13 shows the swimlane process diagram illustrating the process of validating the MTS objects, which are used to validate template data during template creation. After the user chooses to save the project data, as described above, the MTS validation objects are executed in the order described below until an error is encountered or until all possible validation objects have been executed.

The first validation object executed is for the project, so as to ensure that the basic data required to save a template is present, including the submission ID (step 131). The Drivers of Value (i.e., product properties that determine economic value) are then validated (step 132) to ensure that there is at least one Driver of Value and at least one Value Based Milestone for each Driver of Value. The rankings of both Drivers of Value and Value Based Milestones are also validated. Next the issues object cleans the template data and removes empty information before the data is passed to the database (step 133). Validations of Drivers of Uncertainty (step 134), timelines (step 135), ranking of timelines, and estimates (step 136) then follow.

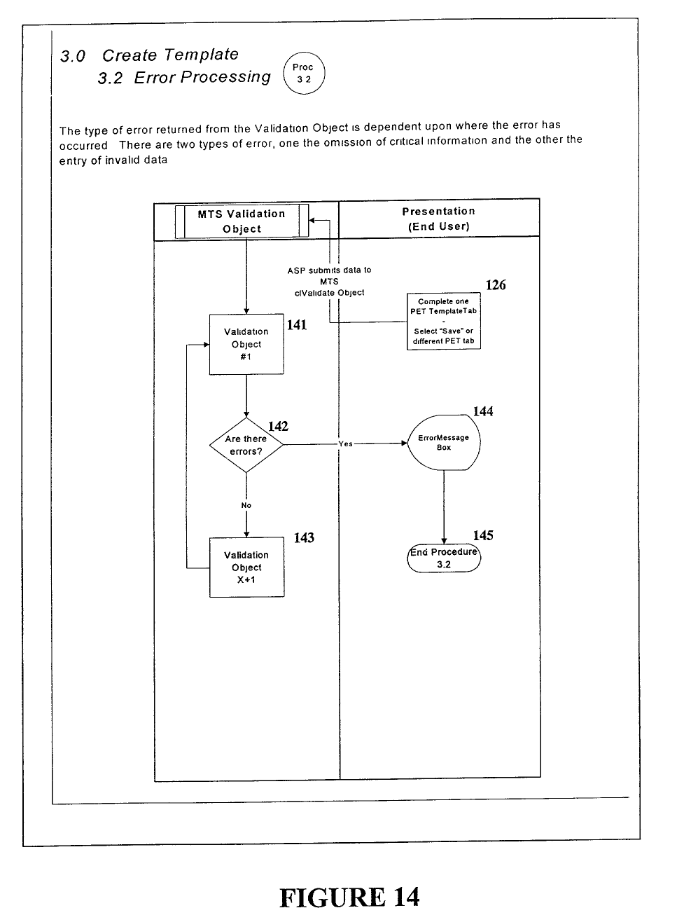

The above validations occur until and unless an error is encountered. If there is an error, error processing according to the procedure described above and shown in FIG. 14 is performed. (Note that in FIG. 13 the error processing routine is indicated by “Proc. 3.2,” which is shown in FIG. 14.) Assuming no error is encountered, the template data is saved and a version number created (step 137) as described above. The PET template with version number is then displayed to the user (step 138).

FIG. 14 shows a swimlane diagram of the process for performing error checks during validation of an object. If no error occurs during validation of an object (steps 141 and 142), the next object is validated. If an error is encountered (step 142), however, an error message is displayed to the user (step 144) and the remaining MTS validation objects are not processed (step 145).

### 3d. Edit Template Module

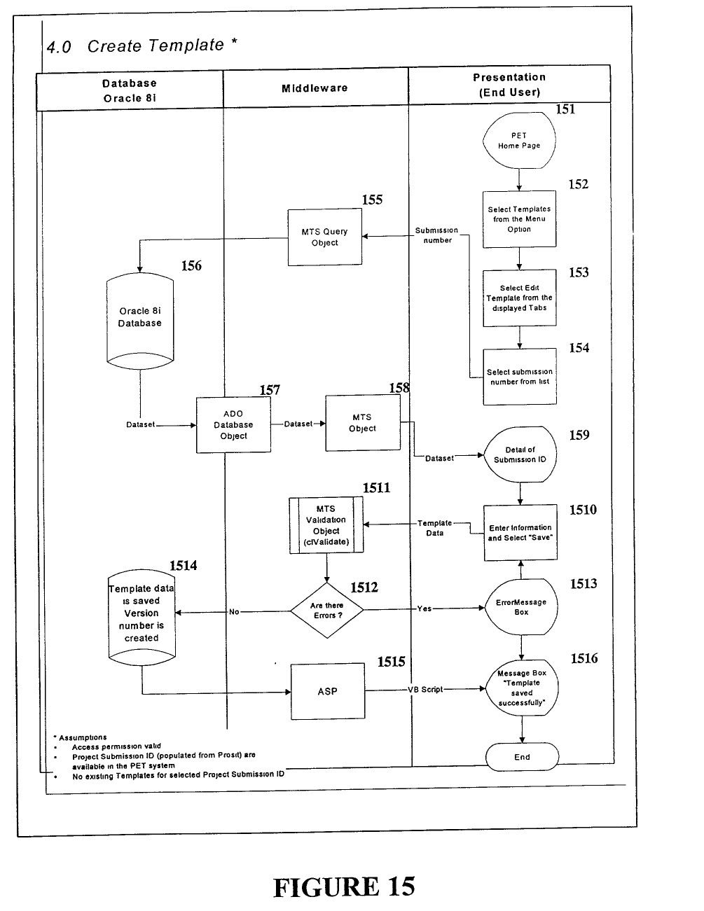

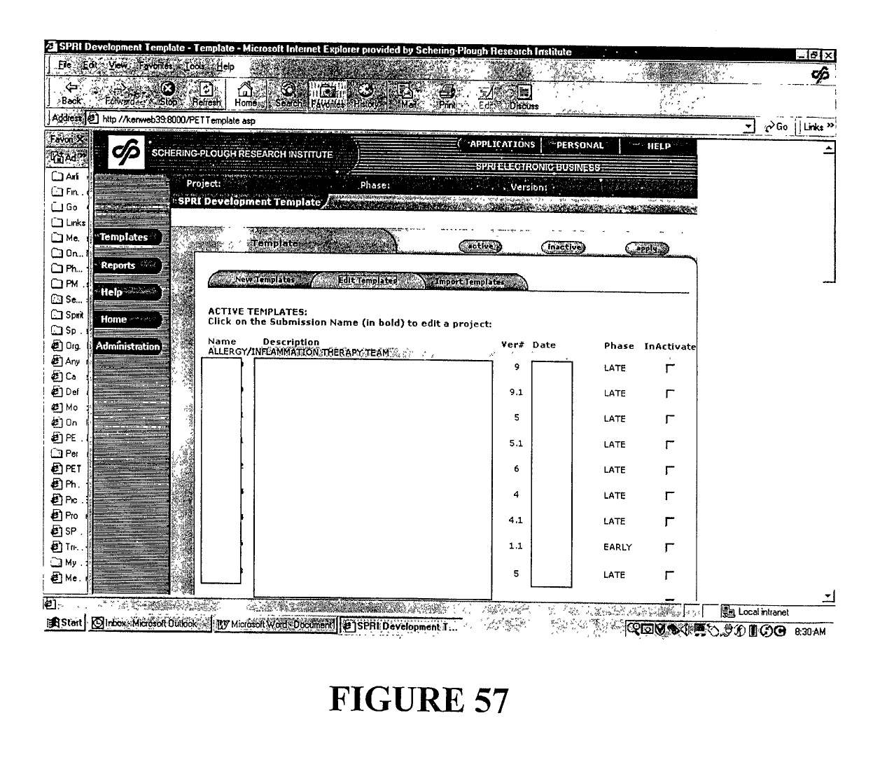

FIG. 15 shows the swimlane process diagram illustrating the process for editing a template. At the PET home page (e.g., FIG. 17) (step 151) the user may select “Templates” 1724 from the list of menu options (step 152), select “Edit Template” from the displayed tabs (step 153), and then select the submission name/number from a displayed list (step 154). See FIG. 57, in which the name, description and date of the templates have been redacted to protect the confidentiality of the information. The middleware then inputs the submission number and uses the Microsoft Transaction Server (MTS) to query the database (e.g., Oracle 8i database) and an ActiveX Data Object (ADO) to interact with the database (steps 155-158). The selected template is obtained from the database and the details of the submission ID are displayed (step 159). The user may then edit the information in the template and save the changes in the database (step 1510). The data is then validated by the same process used during template creation, described above in steps 1511-1516.

### 3e. Create Management Reports Module

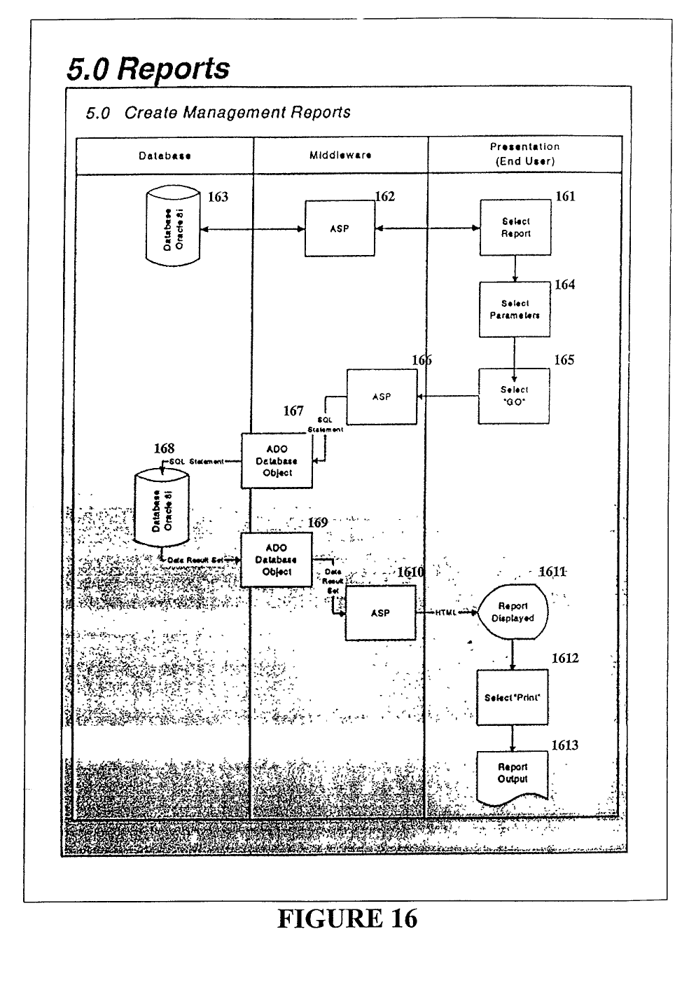

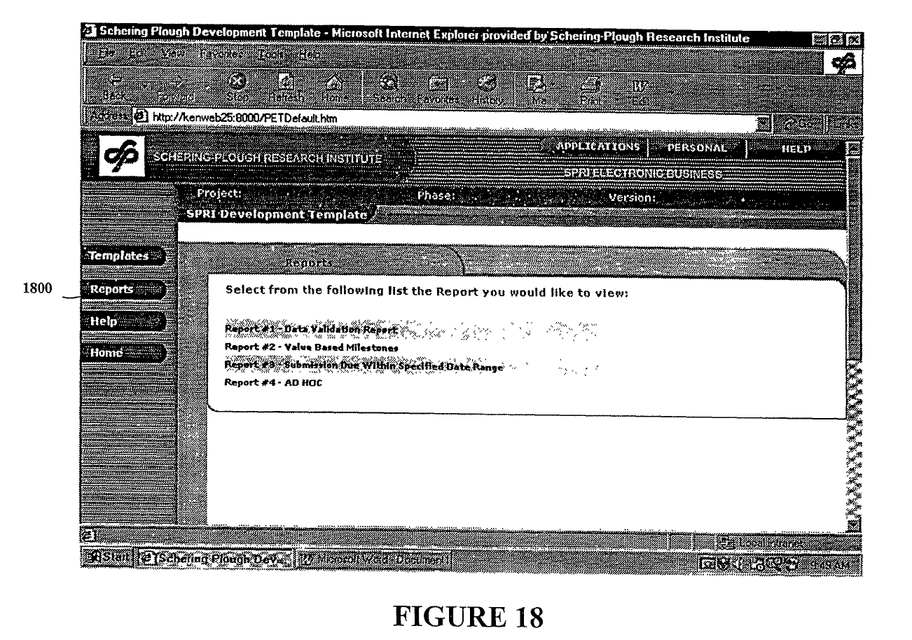

FIG. 16 shows the swimlane process diagram illustrating the process for creating a management report. A screen shot of the “Reports” tab listing some of the types of reports available for selection is shown in FIG. 18. This screen is reached by activating the “Report” button 1800 on the home page. The user selects a type of report (step 161) and the ASP is invoked to obtain the selected report from the database (steps 162 and 163). There are six report options, which include Data Validation Report, Value Based Milestones, Submissions Due, Ad Hoc, Electronic Template (2 pages) and Electronic Template (3 pages). Of these six reports, the first four are created using HTML and the other two are created with the use of, for example, Seagate's Crystal Reports version which must be installed on the computer.

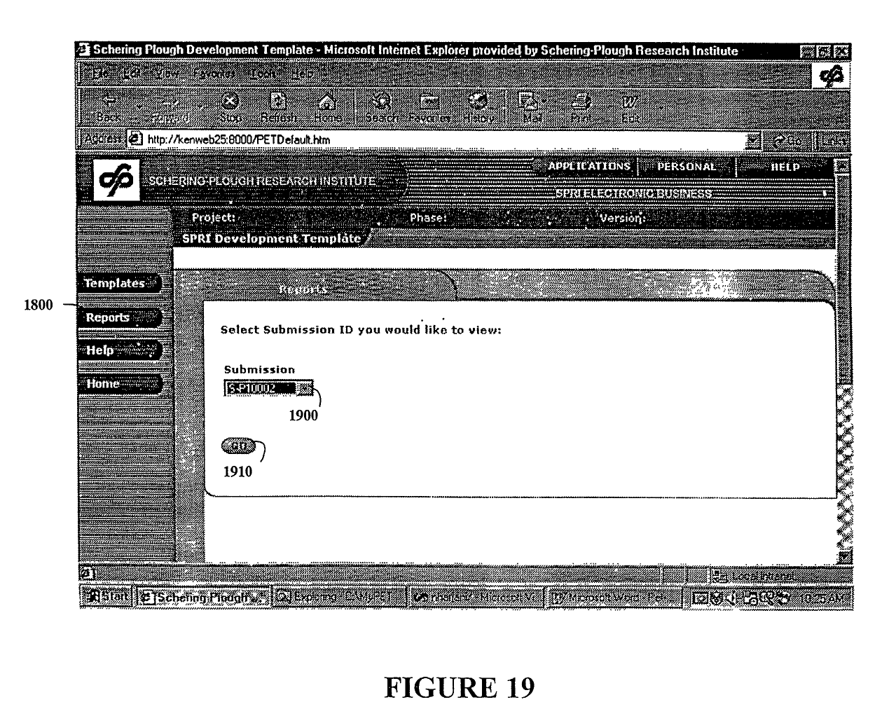

After selecting a report type, the user selects parameters (step 164), such as Submission ID from drop-down menu 1900 as shown in the screen shot illustrated as FIG. 19, and activates the “Go” button 1910(step 165). The ASP is then again invoked to obtain, using the ADO database object, the selected parameters from the database (steps 166-1610). The report is then displayed (step 1611), and the user may choose to print the report (steps 1612 and 1613).

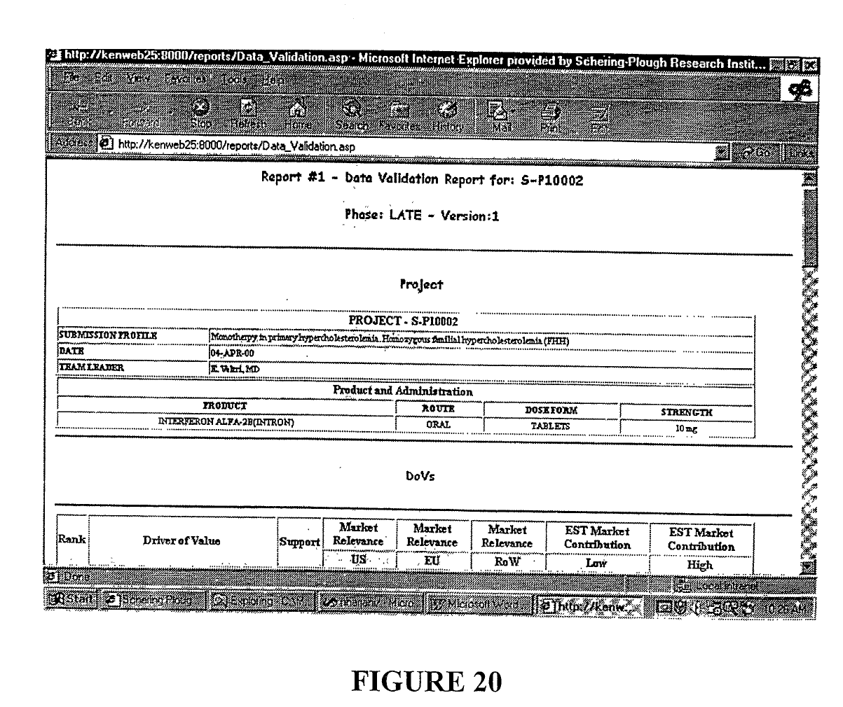

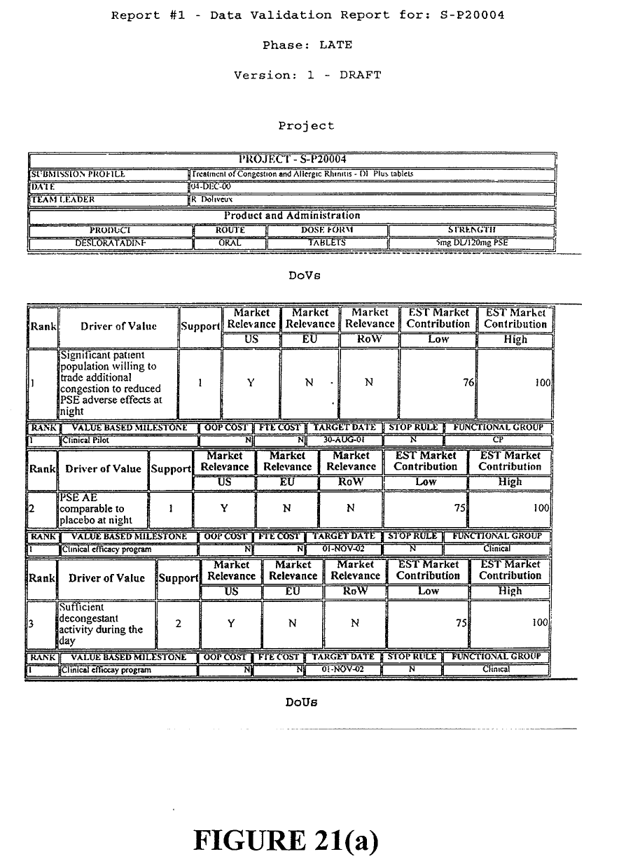

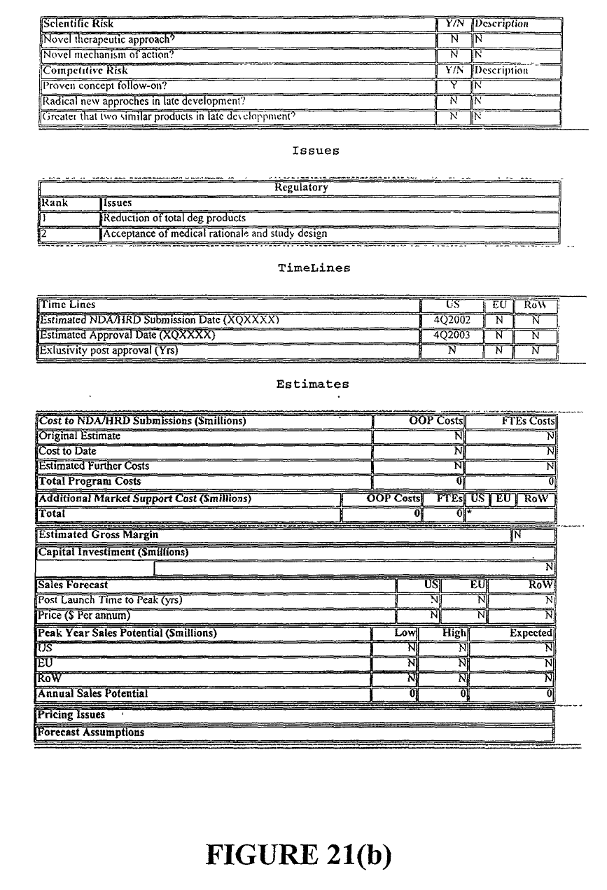

A screen shot of the Data Validation report is shown in FIG. 20, and an example of a printout of a Data Validation Report is shown in FIGS. 21(a) and 21(b). A Data Validation report is essentially a rough data dump showing information such as project identification information, Drivers of Value, Drivers of Uncertainty, regulatory issues, timelines, and estimates.

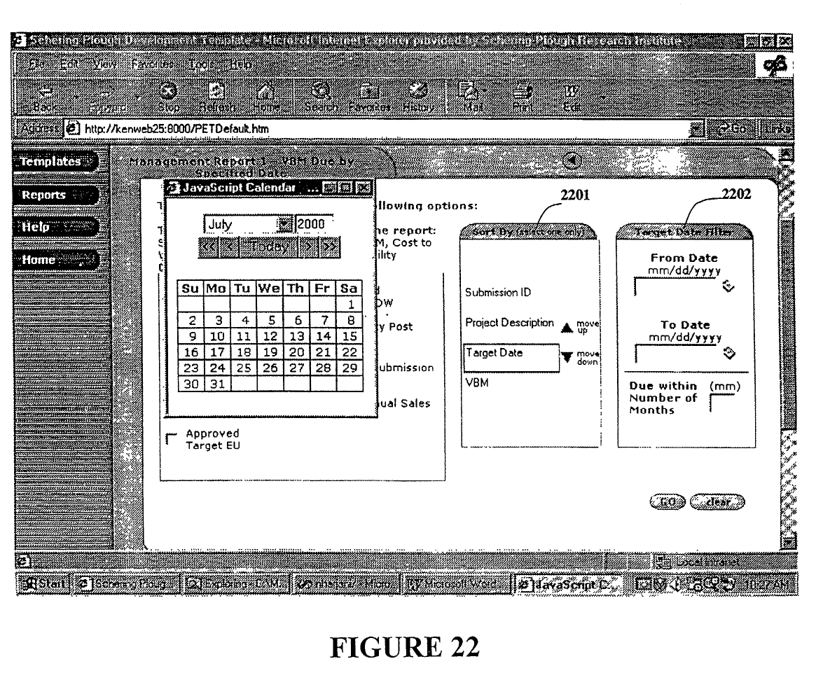

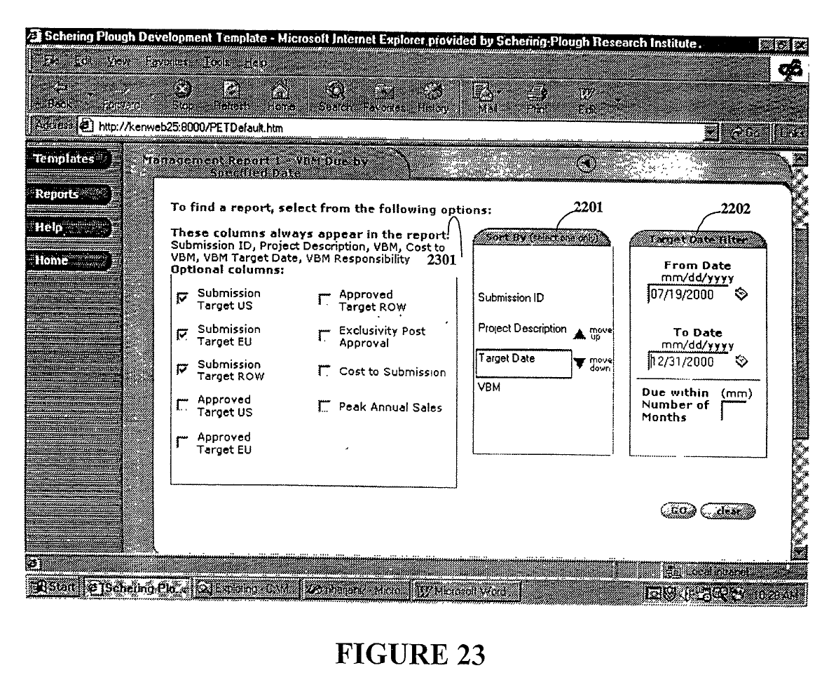

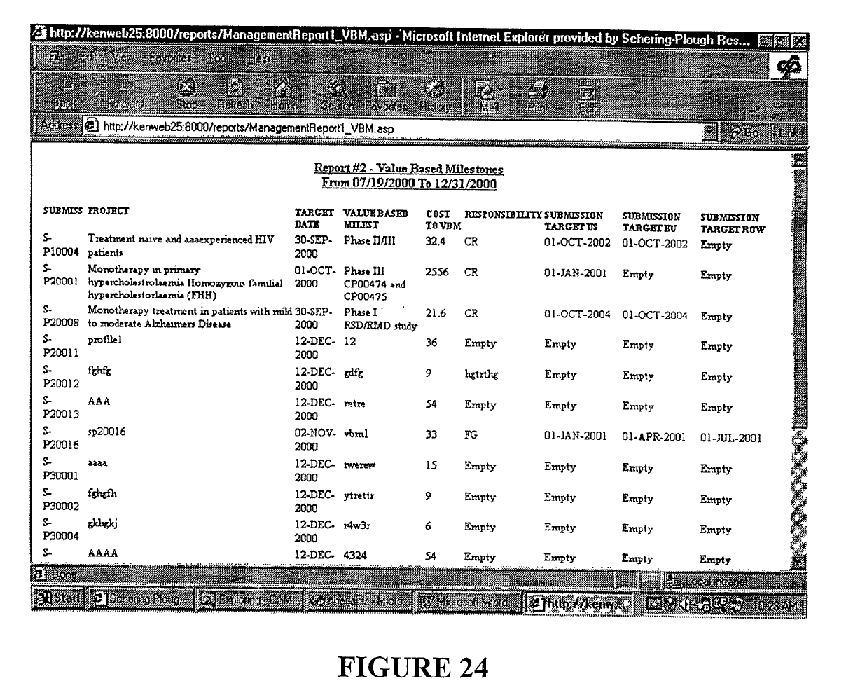

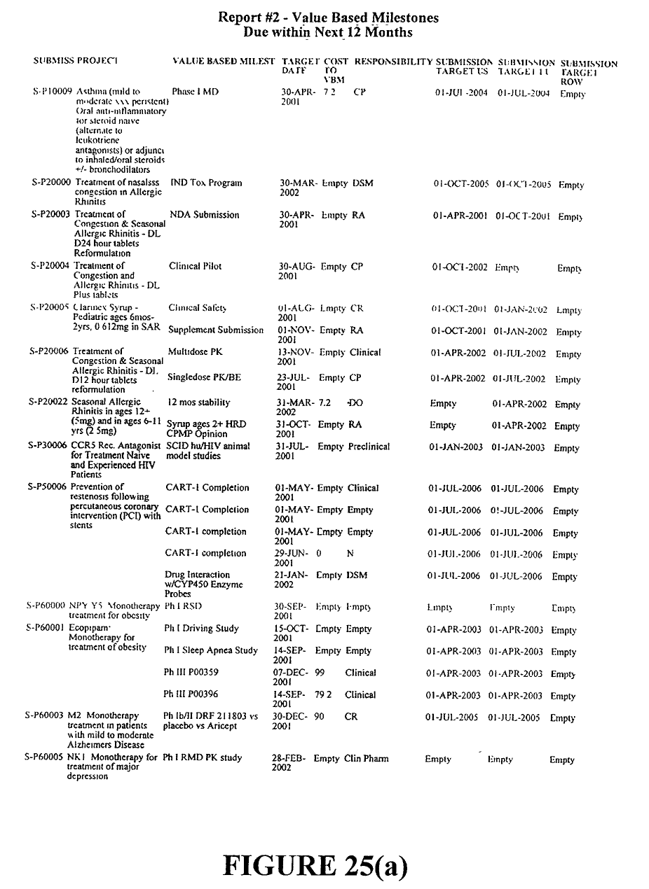

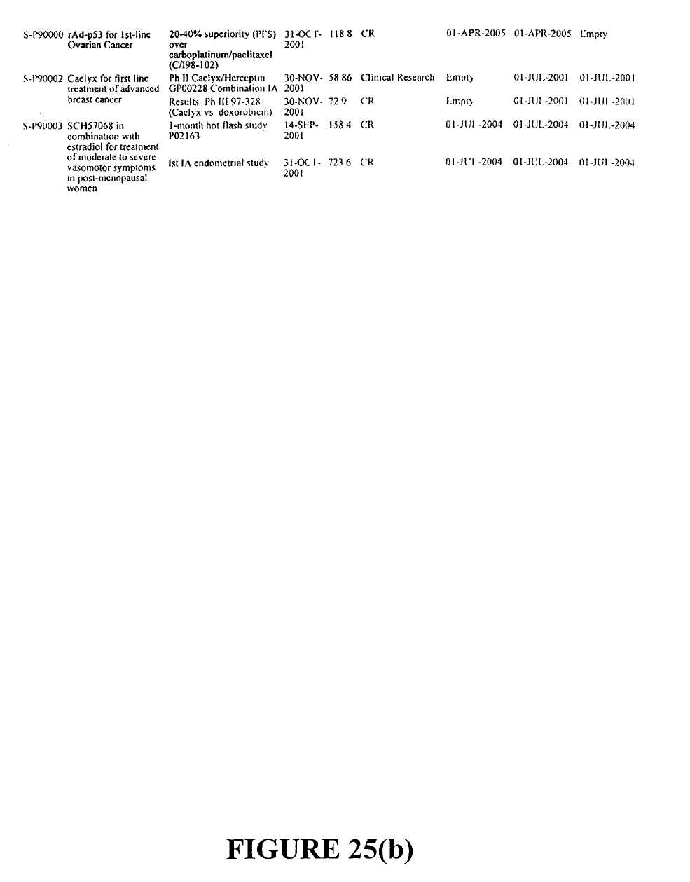

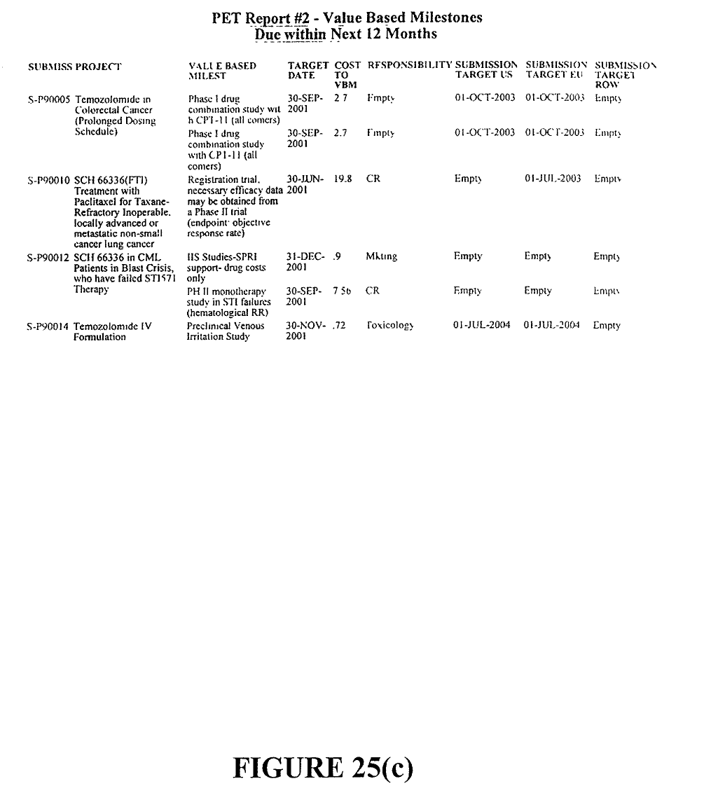

Screen shots of the Value Based Milestones report tab are shown in FIGS. 22 and 23, a screen shot of an example of a Value Based Milestones report is shown in FIG. 24, and an example of a printout is shown in FIGS. 25(a) through 25(c). The Value Based Milestones report tab shown in FIGS. 22 and 23 includes a sorting function 2201 with the option to sort by submission ID, project description, target date and Value Based Milestone (VBM). There is also a target date filter 2202 allowing the user to filter out projects outside of a specified date range. The report to be generated is designed to always include columns for submission ID, project description, VBM, Cost to VBM, VBM target date and VBM responsibility, but this is merely a design choice. The user also has the option to use a selection function 2301 to add any one or more of the following columns: submission target US, submission target EU (Europe), submission target ROW (Rest Of World), approved target US, approved target EU, approved target ROW, exclusivity post approval, cost to submission and peak annual sales. Examples of the resulting Value Based Milestones report are shown in FIG. 24, which is a screen shot, and in FIGS. 25(a) through 25(c), which are an actual printout of a report.

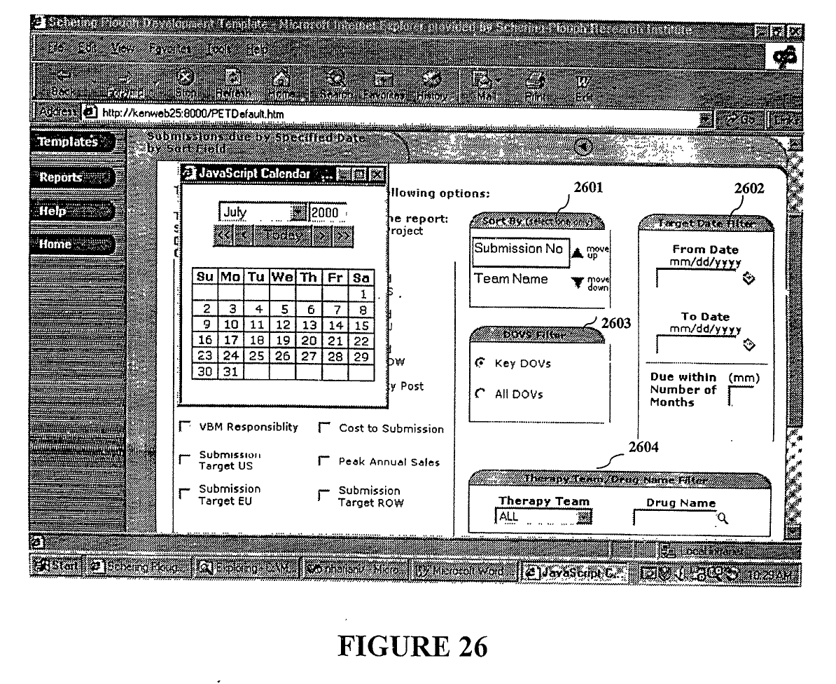

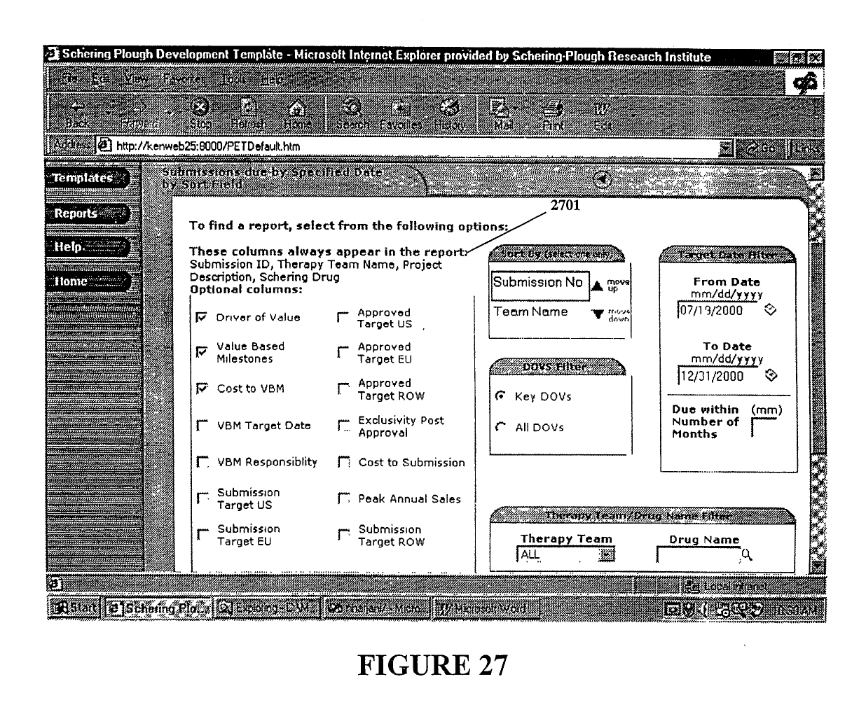

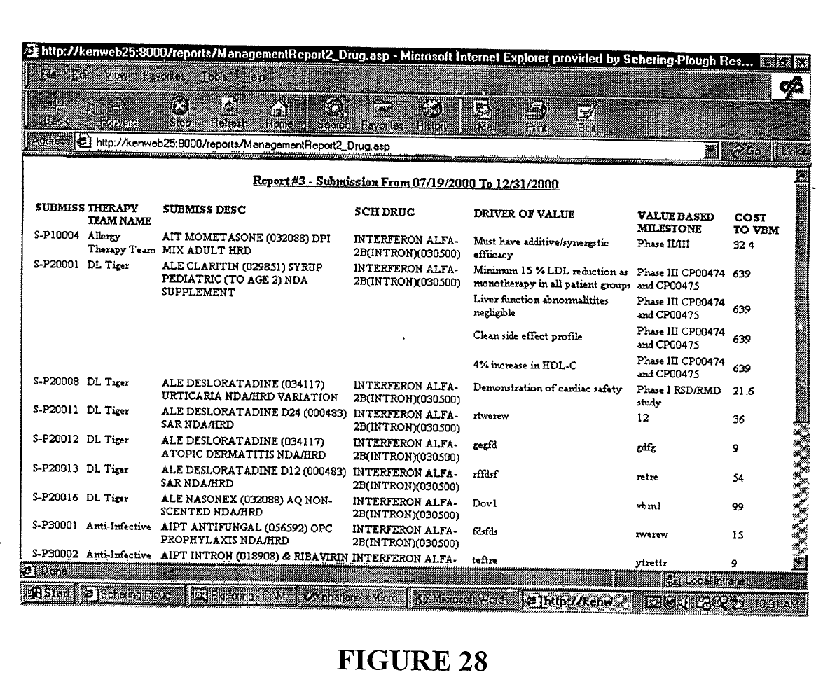

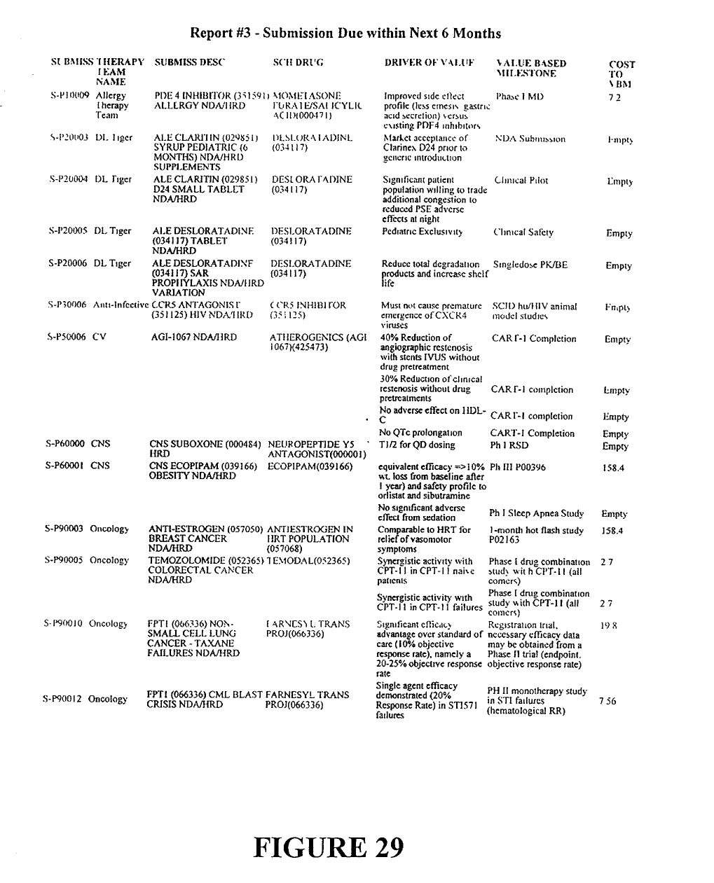

Screen shots of the Submission Due report tab are shown in FIGS. 26 and 27, a screen shot of an example of a Submission Due report is shown in FIG. 28, and an example of a printout is shown in FIG. 29. The Submission Due report tab shown in FIGS. 26 and 27 includes a sorting function 2601 with the option to sort by submission number or team name, and a target date filter 2602 allowing the user to filter out projects outside of a specified date range. A Drivers of Value (DOV) filter 2603 allows a user to select between displaying all DOV or only the key DOV. A therapy team/drug name filter 2604 allows a user to limit the report to particular therapy teams or drugs. The Submissions Due report is designed to always include columns for submission ID, therapy team name, project description, and drug, but this is merely a design choice. The user also has the option to use a selection function 2701 to add any one or more of the following columns: Driver of Value, Value Based Milestones (VBM), cost to VBM, VBM target date, VBM responsibility, submission target US, submission target EU (Europe), approved target US, approved target EU, approved target ROW, exclusivity post approval, cost to submission and peak annual sales, and submission target ROW (Rest Of World). Examples of the resulting Submissions Due reports are shown in FIG. 28, which is a screen shot, and in FIG. 29, which is a printout of the report.

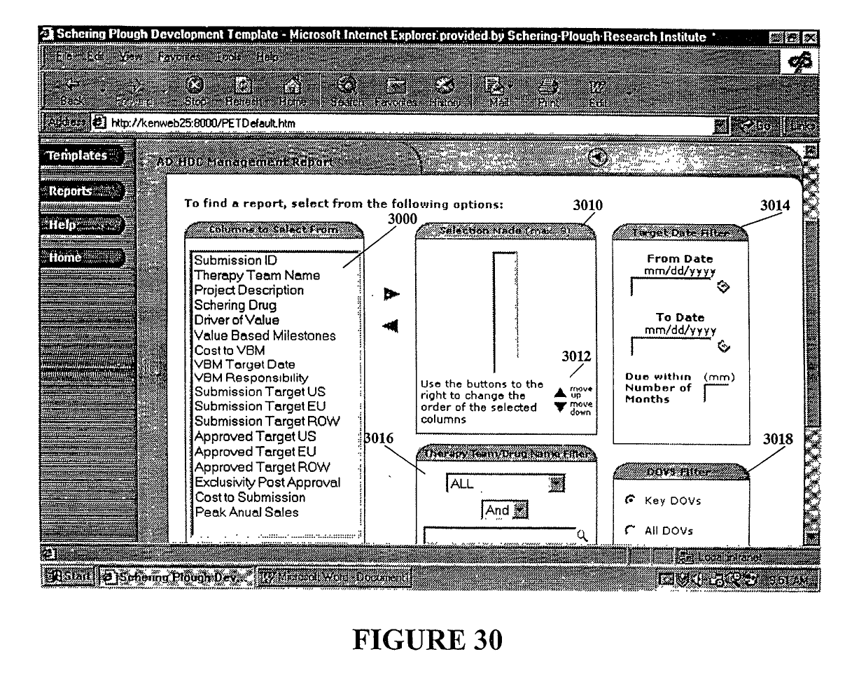

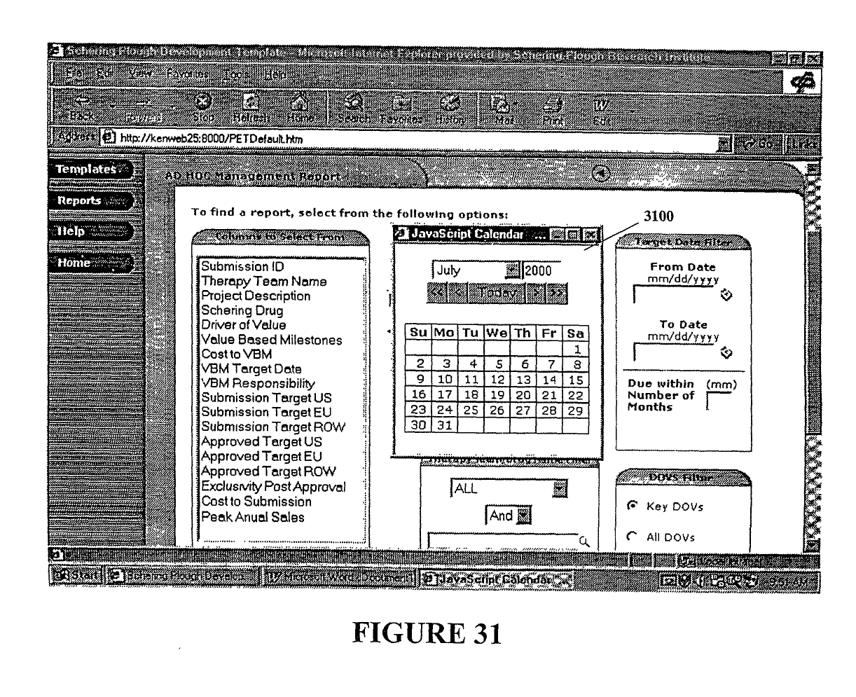

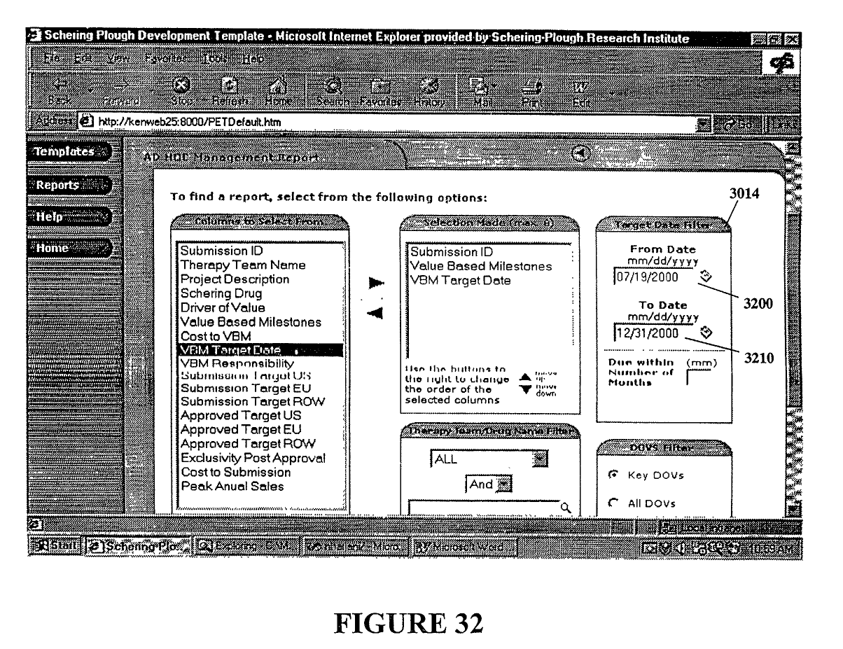

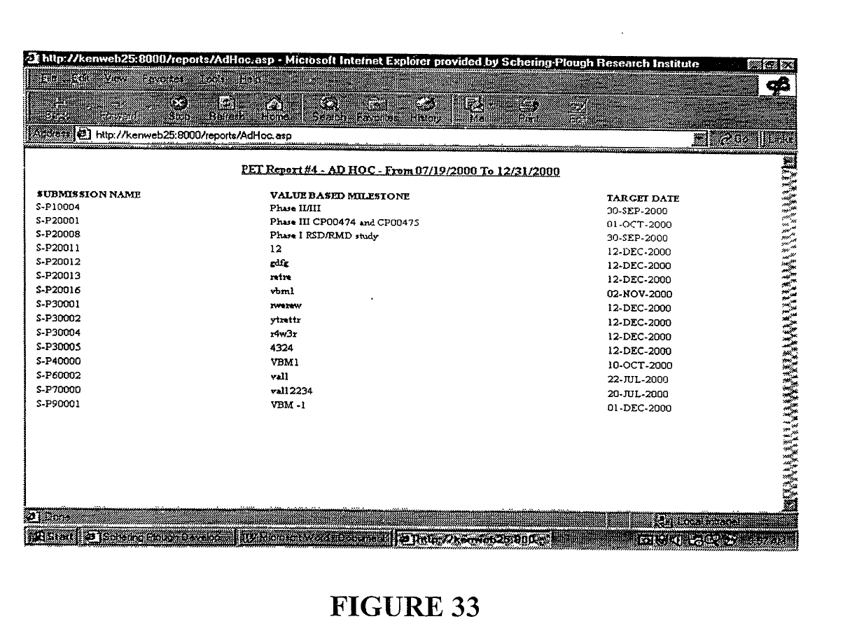

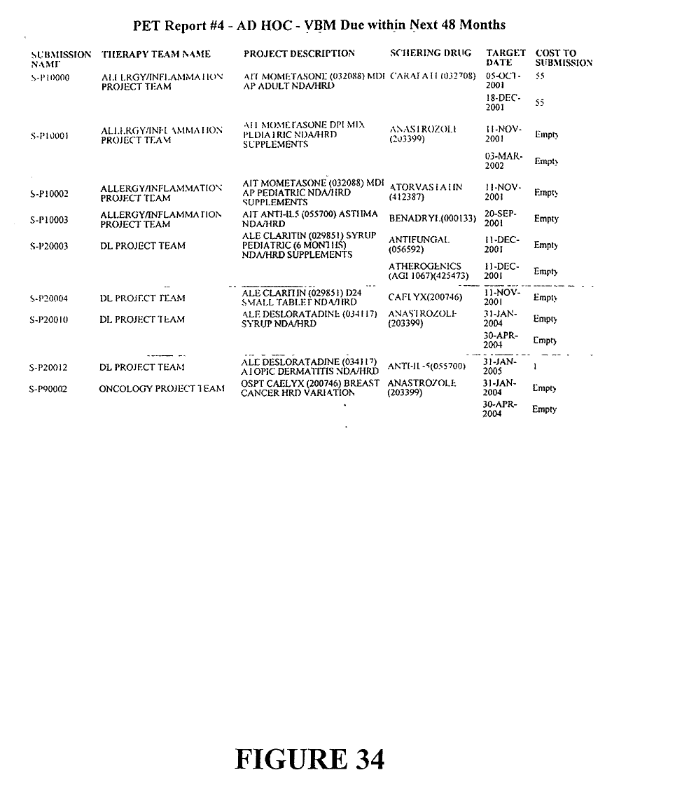

Screen shots of the Ad Hoc report tab are shown in FIGS. 30-32. An Ad Hoc report is a report that is tailored by the user. The user may select fields from the list 3000 in the left-hand portion of the screen, which then appear in the column 3010 in the middle portion of the screen. The user may choose the print order of the fields by using the arrows 3012 located below the column of selections made. The user may also filter the displayed data by date using the target date filter 3014 in the right-hand portion of the screen. Using this filter causes a calendar 3100 to appear, by which the dose range can be selected (FIG. 31). The result is shown in filter 3014 in the elements identified by reference numerals 3200 and 3210 in FIG. 32. The user can also filter the therapy team/drug name using the filter 3016 located in the lower middle portion of the screen. Finally, in FIG. 30 the user may choose to display only Key Drivers of Value or all Drivers of Value using the filter 3018 in the lower right of the screen. A screen shot of an example of an Ad Hoc report is shown in FIG. 33, and a printout of an example is shown in FIG. 34. The example report shown in FIG. 33 indicates that the user selected to display submission name, value based milestone, followed by target date. The example report shown in FIG. 34 indicates that the user selected to display submission name, therapy team name, project description, drug, target date, followed by cost to submission.

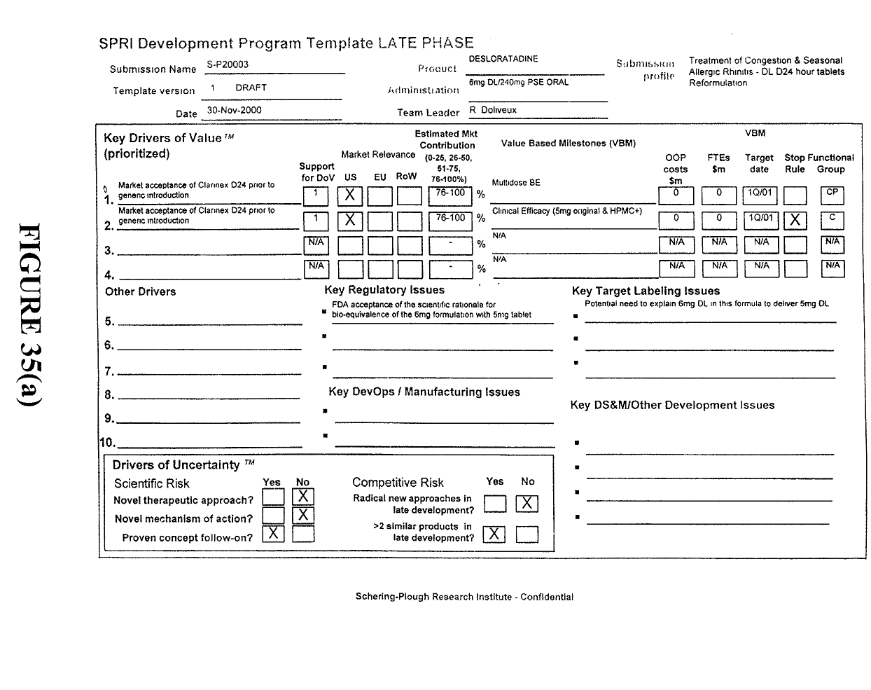

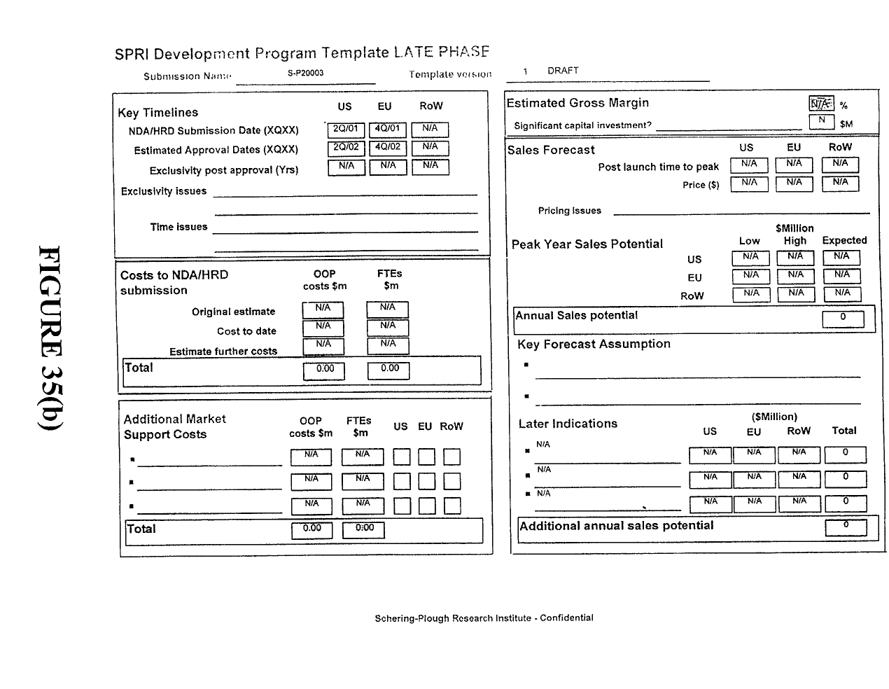

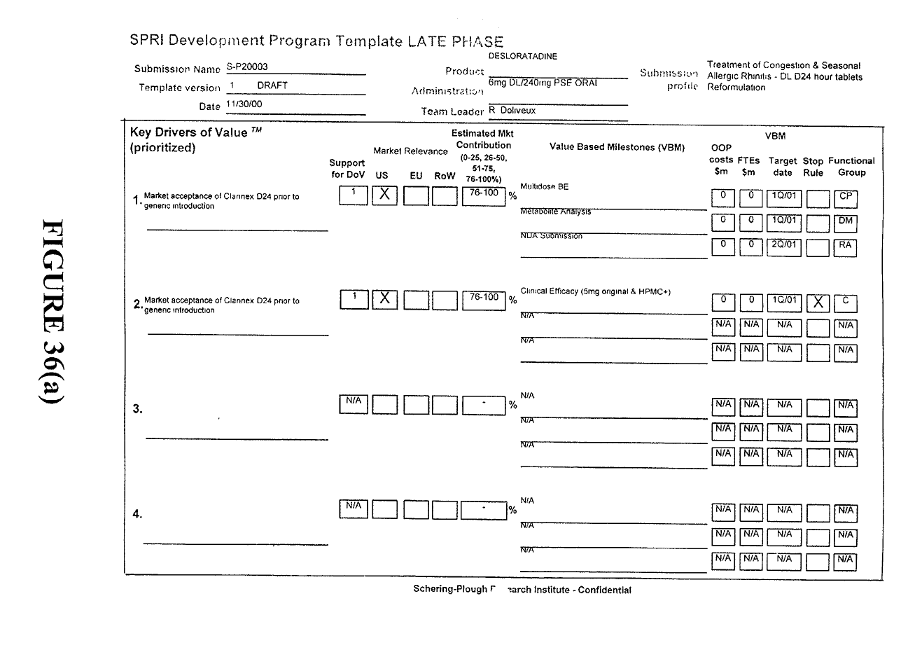

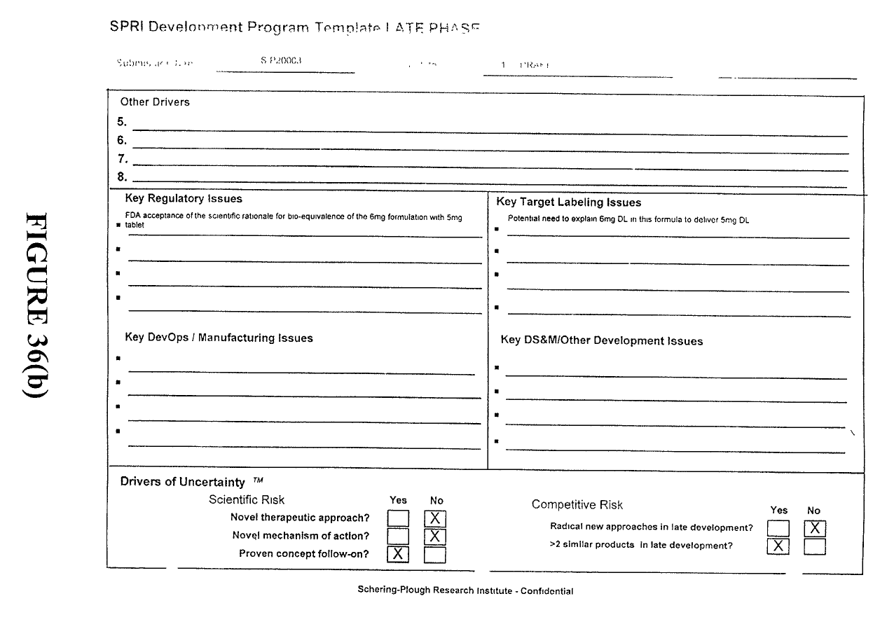

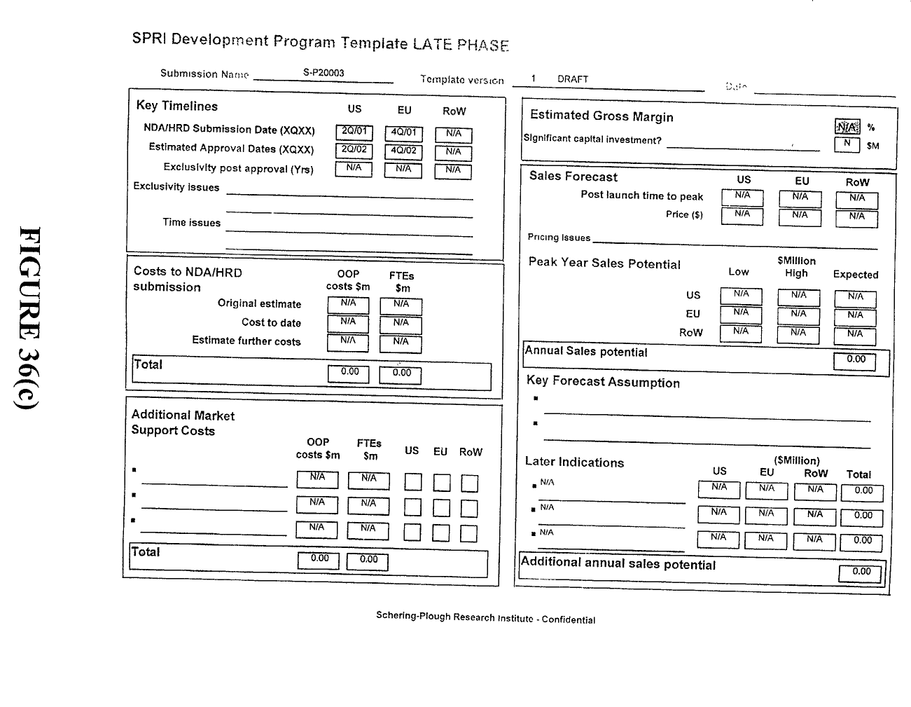

Electronic template reports provide the user with information on project development status. The design of the Electronic Template reports involves the insertion of an unbound field (i.e., a field of unspecified length) into the report at design time, and binding the field object to an actual database field at runtime. Parameters pass from the user interface to an Oracle procedure that retrieves the report data. PL/SQL function and procedure are created to form a dynamic SQL statement based on the user's input from the report interface. This design allows the Crystal Reports interface to take the user's selection as unbound fields and bind them to a database at runtime. An example of the two-page Electronic Template Report is shown is FIGS. 35(a) and 35(b). An example of the three-page Electronic Template Report is shown in FIGS. 36(a) through 36(c). The difference between the twopage report and the three-page report is the three-page report includes additional Value Based Milestones for the Key Drivers of Value.

### 4. Screen Navigation

For all the screens, the fields with a magnifying glass can not be edited and instead use a pull-down box and a lookup list; a new Internet Explorer window is opened with this pull-down box. Those fields that do not have the magnifying glass, however, can be edited.

The “Clear” button, i.e., button 1726 in FIG. 17, clears all data currently on the screen. The “Remove” button, i.e., button 1728 in FIG. 17, physically removes the record from the screen. And if the data was saved in the database, the “Remove” button will remove the record from the database upon re-saving. The “New” button 1730 is used to create a new line when entering the product 1716, route 1718, dose form 1720 or strength 1722 information.

The user may navigate throughout the system in multiple ways. For example, the user may use the typical browser back arrows 1732, 1734 to go back and forth one screen at a time. Alternatively, the user may use the tabs 1736 on the top of the screen or the vertically arranged buttons 1738 (of which template button 1724 is one) on the left side of the screen to navigate to another screen of the template.

History icons 1740 (FIG. 17) are available on various tabs. When the user clicks a history icon, a new window displaying an Audit History for the associated field is displayed.

Finally, entered data is not saved until the user actually performs a save operation. Entered data is saved in a buffer area until the session terminates (voluntarily or by system error/failure). Error messages will be displayed if applicable during a save.

### 5. Security

The system has two levels of security. The first is the Microsoft Internet Information Server (IIS) 4.0 Web Server Basic Authentication, which is web server software from Microsoft that runs under Windows NT. It supports Netscape's SSL security protocol and turns an NT-based PC into a web site. Microsoft's Web browser, Internet Explorer, is also included. A list of all valid users is added to the NT production server users group. These are the only users who have access to the system. The list is manually maintained and every new user must be inserted into the user NT database according to the procedure described in connection with FIGS. 10 and 11 (steps 113-115 and 1112). Security rules like auditing and password expiry are maintained by the NT system.

The other level of security is the Clinical Systems Common Security Model (CSM), which is provided by Oracle (steps 117, 118, 1110 and 1111). CSM allows the user to go into the system and OPERA seamlessly, without going through security twice. CSM is designed to limit and control what access each user has within a given application. There are several security layers that are considered, and can be extended where needed. Users are assigned to specific applications. Within each application the users will have an individual role assigned to them. A role may limit them to read only, or give them update and delete privileges, etc. The business processes of creation, modification and termination of user accounts, as described above, involve changes to the Common Security Model.

CSM was designed based on the needs of the application. The unique implementation of security roles for planners prohibits the planner from viewing information within and between company teams and projects with which the planner is not associated. In affect, each planner can only view information on his clinical trial. This secure environment maintains project information autonomy and integrity. However, company management has full access to the cross-referential project information, i.e., they can view all of the information for all projects, and can view information that cross-references different projects.

There are four separate types of access rights that control the nature and extent of a user's access to the system, based upon the user's job description or role. In other words, there are different views into the software's central project database designed for project super-users, executives, managers and planners. Role assignment and the assignment of therapy team area(s) is done via the CSM. The super-user role has all rights to view and edit submission template information across all therapy teams. The executive role has rights to view all submission template information across all therapy teams. The manager role has rights to read all submission template information across one or more assigned therapy teams. The planner role has rights to read and write submission template information across one or more assigned therapy teams.

The Microsoft IIS Web Server Basic Authentication and the CSM are well known software packages that serve merely as examples of possible levels of security systems. Those skilled in the art appreciate that other comparable software packages could alternatively be used without departing from the spirit and scope of the invention.

### 6. Templates

### 6a. Early Phase Template

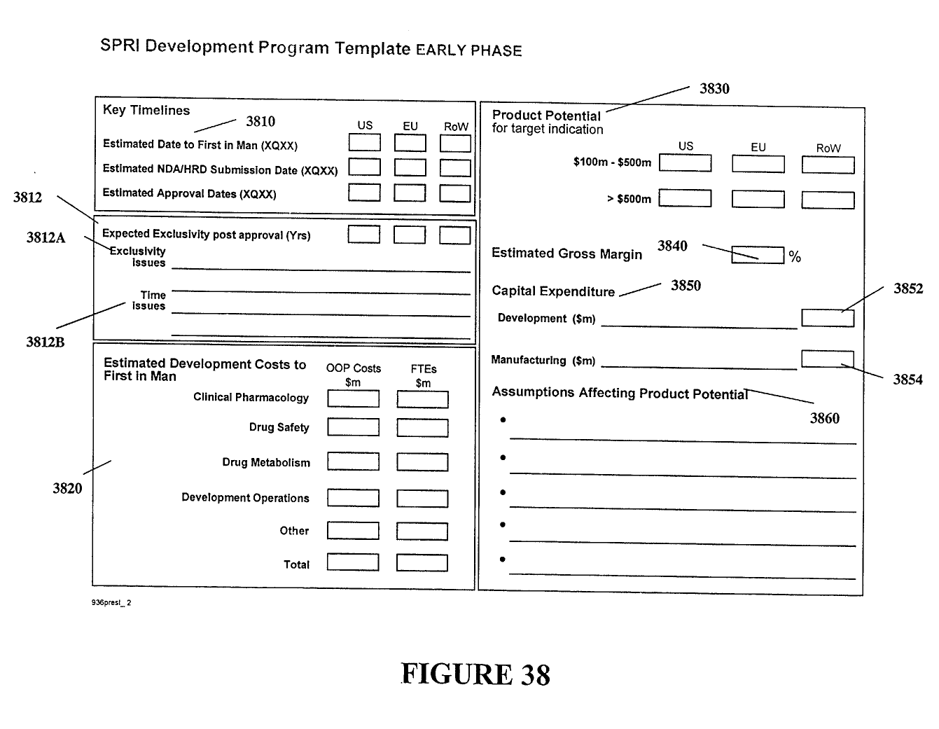

FIGS. 37 and 38 show the Early Phase template, which is designed to capture information about a project up to the first experience in humans. Drivers of Value, unmet medical needs, estimated costs prior to the first experience in humans, and the commercial potential for the drug are recorded in the template.

The first page of the Early Phase template, shown as FIG. 37, includes the template identification fields, such as a “Project ID” field 3710, a “Template Version” field 3712 and a “Date” field 3714. The “Project ID” is the identification of the template by the company's project tracking number. The “Template Version” (e.g., 01, 02, etc.) informs a user of how many times the project template has been updated, and hence how many other templates in the series are available for review. The “Date” indicates when the current version of the template was completed and updated by the team leader.

This first page of the Early Phase template also includes product identification fields. The “Product” field 3716 indicates the relevant chemical entity, which is identified by either a company-assigned number or a name. The “Administration” field 3718 indicates how the product should be given or administered to the patient. The information in this field should be as informative as possible, and should consider issues such as the route of delivery (i.e., oral, IV or subcutaneous injection), and if known, the dosage (i.e., quantity, frequency). The “Team Leader” field 3720, as its names implies, identifies the team leader of the project. The “Submission Profile” field 3722 includes a description of the indications for which the submission will be filed, and should include all indications for the submission (not the product), treatment or prophylaxis, patient population or sub-population, and specific factors (combination therapy, part of a drug package, induction dosing). “Drivers of Value” (DoV) fields 3724 indicate those properties of the product that will determine the economic value of a product. That is, “Drivers of Value” are those properties of the product that will determine the product's economic value in patient management, and hence its breadth of usage. They will affect the market value of that product either positively or negatively.

Examples include efficacy and safety compared with current standard therapy. The Drivers are prioritized by the size of their potential impact on product sales. The highest priority drivers, the “Key Drivers of Value,” may be critical to success or failure. Precision and detail by the user in entering information into this field are important. That is, if superior efficacy is required, it is important to indicate in which categories the superiority is required, e.g., eradication of a pathogen from clinical isolates or an increase in overall survival compared with current standard therapy.

The “Support for Drivers of Value” field 3726 captures what currently available data indicate about the likelihood that a Driver will be achieved, or how strongly predictive the existing data is. A score of “1” indicates that highly positive predictive data is available; “2” indicates that some positive predictive data is available; “3” indicates that no predictive data is available; “4” indicates that predictive data are negative; and “5” indicates that predictive data are strongly negative. For example, for animal toxicology studies with provocative findings in which there are Phase I problems with excessive toxicity, wherein there are both weak positive and weak negative data, the “Support for Driver of Value” would be expressed as 2/4.

Achievement of or failure to achieve a Driver of Value will impact on the marketability of the product and hence the size of potential sales. Consequently it is important for the user to assess subjectively the value of the Driver. The results of this assessment are entered into the “Estimated Market Contribution” field 3728. At this early stage in the product development a broad range of impact should be estimated. A fall Drivers of Value analysis, however, should back the estimate. In this example the ranges are 0-25, 26-50, 51-75 and 76-100%. But ultimately a guestimate will not be sufficient. Also, it is important to note that the estimated market contributions of the Drivers are not additive. Each contribution should be estimated on the assumption that all other Drivers are achieved. For instance, while the value of the efficacy driver will increase with improving efficacy, simultaneously the value of the side-effects driver may decrease if side-effects increase.

A “Value Based Milestone (VBM)” is a measurable, deliverable, tactical milestone that assesses progress in attaining a Driver of Value. It is the earliest definitive point of access to the information that determines whether or not that Driver has been achieved. The Drivers of Value, in conjunction with Value Based Milestones, are a useful tool for incremental decision-making. If the Driver of Value is not met, management has the critical information necessary for decision-making.

Examples of Milestones include clinical trial interim analysis (possibly from another indication), a Phase I trial if safety is the Driver, and a meeting with the FDA. The user should, whenever possible, identify the degree to which the product must exceed current therapy. For example, if 25% greater superiority is mandatory for success and only 20% superiority is achieved, it should be clear whether there is still a product. The VBMs are listed in field 3730.

The “OOP (Out of Pocket) Cost” field 3732 includes all costs (except those for Full Time Equivalents, described in the next paragraph) that must be spent to achieve the Value Based Milestone. These costs should include subsequent unavoidable costs. For instance, if an interim analysis of a clinical trial provided negative data for a Driver of Value, resulting in a decision not to proceed with the trial, then the costs of stopping the trial should be included, as they are part of the minimum cost of obtaining that driver.

The “FTEs” field 3734 includes Full Time Equivalents (FTEs), or the equivalent of employees working full-time, in terms of their dollar costs to the project rather than man years. This is provided because the template is used for evaluating costs, rather than tracking resource availability. The information gathered to generate the FTE costs (FTEs required by year and specialty and cost per FTE), however, could ultimately be accessed through a drill down (i.e., detailed analysis of supporting documentation) to facilitate resource planning.

The “Target Date” field 3736 indicates the date at which the Value Based Milestone will be reached. For example, this could be when an interim analysis of results is completed, or when a meeting with the FDA is scheduled. Clearly it is important to reach the Value Based Milestone at the earliest possible date.

The “Stop Rule” field 3738 indicates whether the project will be stopped if the Driver of Value is not achieved. This could be either a decision not to proceed with the trial or a temporary stoppage for re-evaluation.

The “Functional Group” field 3740 indicates which source area is responsible for generating a particular Driver of Value. Examples of Functional Groups include Regulatory (RA), Toxicology (Tox), Clinical Pharmacology (CP), and Development Operations (DO).

Other Drivers of Value are inserted in the “Other Drivers of Value” field 3742 as a record that they have been evaluated and found to be of lower priority for reason of lesser impact on market share than the Key, or top four, Drivers of Value discussed above.

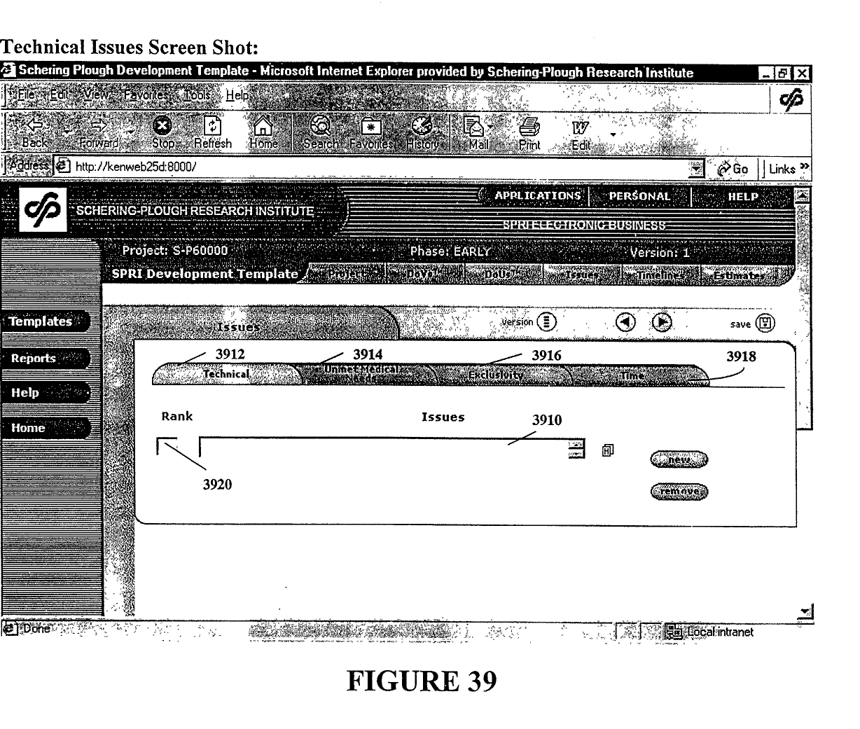

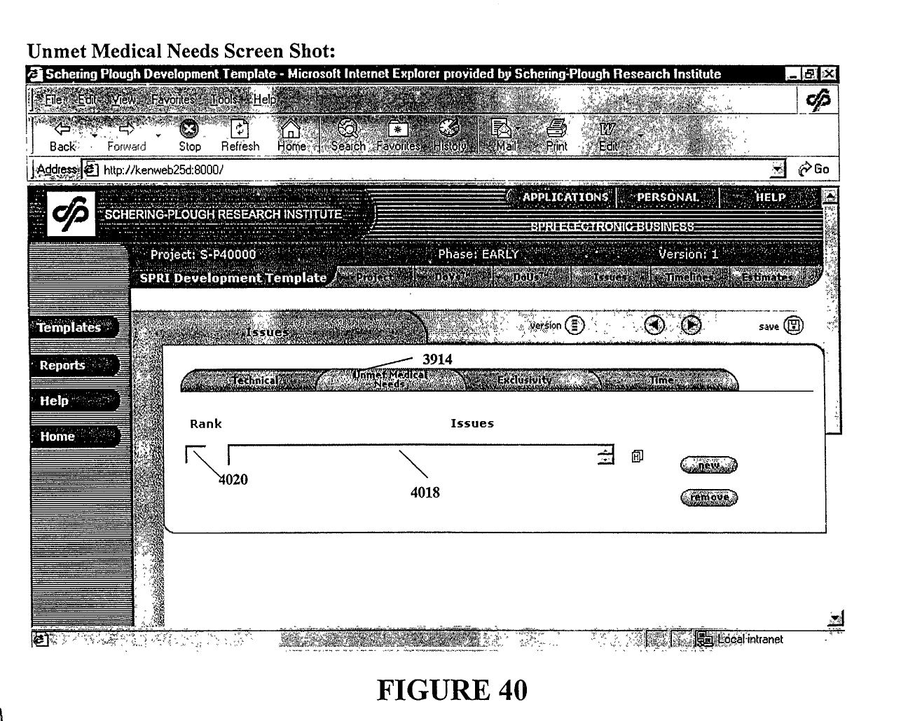

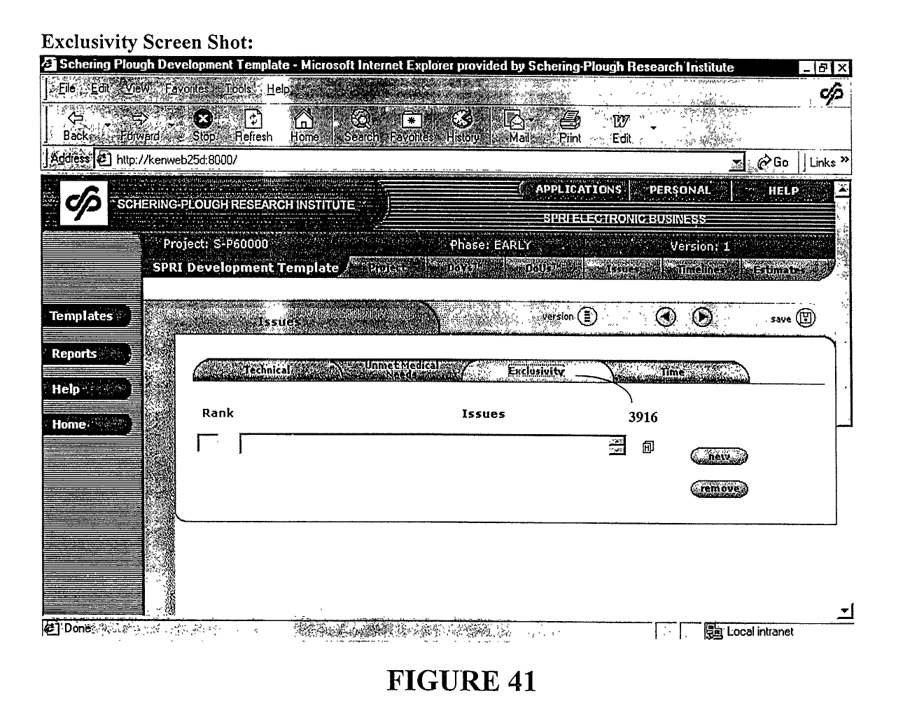

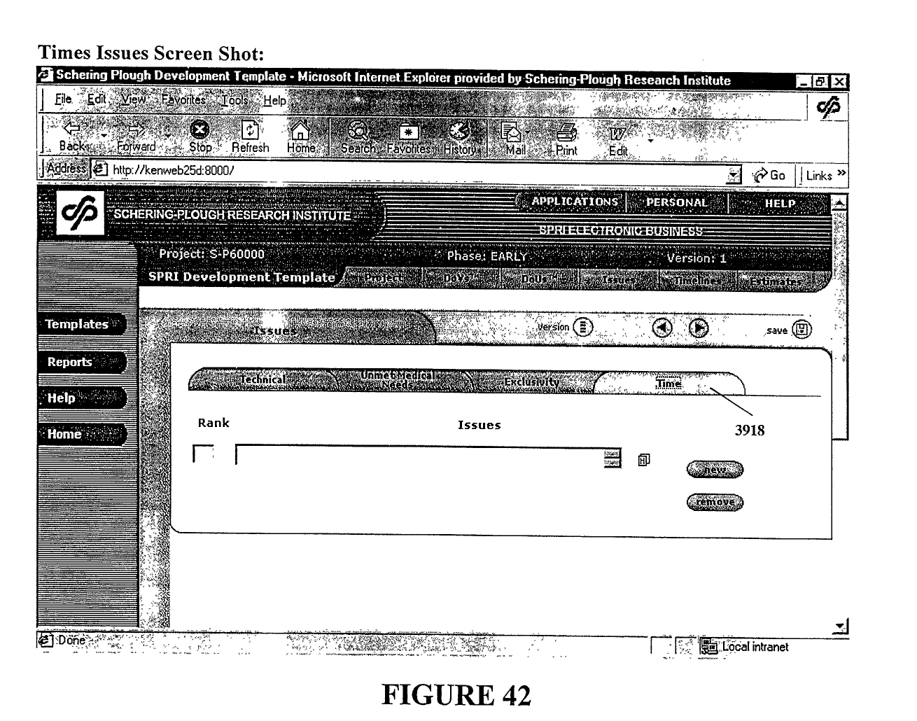

The “Technical Issues” field 3744 indicates whether there are any outstanding technical issues to be resolved. This field would include any development or manufacturing issues that could have a significant impact on the progress of the project. As shown in the screen shot shown as FIG. 39, the Early Phase template “Issues” field 3910 has four tabs—“Technical” 3912, “Unmet Medical Needs” 3914, “Exclusivity” 3916, and “Time” 3918. Screen shots of these tabs are shown in FIGS. 39-42. The “Unmet Medical Needs” field 3746 of the template (FIG. 32) should capture in as much detail as possible concerning the precise unmet medical need the product is expected to meet, and to what extent the product will meet that need. As with the technical issues 3910, each medical need issue 4018 specified on the screen (FIG. 40) should be ranked by inserting a number in the rank field 3920, 4020.

“Drivers of Uncertainty” are those factors which may affect the development, distribution and market value of the product. The “Drivers of Uncertainty” methodology includes both Scientific and Competitive Risk factors. It will therefore affect the market value of that product either positively or negatively, e.g., efficacy and safety compared with current standard therapy. The Drivers of Uncertainty may be significant to project success.

The “Drivers of Uncertainty” section 3748 at the bottom of the template page includes a “Scientific Risk” field 3750 and a “Competitive Risk” field 3752, which allow the user to choose between “Yes” and “No.” The “Scientific Risk” fields include evaluations of the product risk. The “Novel Therapeutic Approach” field, which involves high risk and high reward, could be a new therapeutic modality, such as immunization against colon cancer. The “Novel Mechanism of Action” field indicates whether the product is a new chemical class, such as a new group of anti-depressants. The “Proven Concept Follow-on” field is the least novel, but also the least risky, that is, low risk and low reward. Taking Ziracin, as an example, the therapeutic approach of using an antibiotic to fight infections is well established. An alternatively proven concept may be an indication extension of an existing product, or a development of a proven product such as Intron and PEG-Intron, for which there is already a knowledge base.

The “Competitive Risk” fields 3752 capture the competitive environment the product will be entering. They indicate whether competitors are about to enter the market. And if there is strong competition, how strong it is and whether the competing products have similar profiles or a competitive edge.

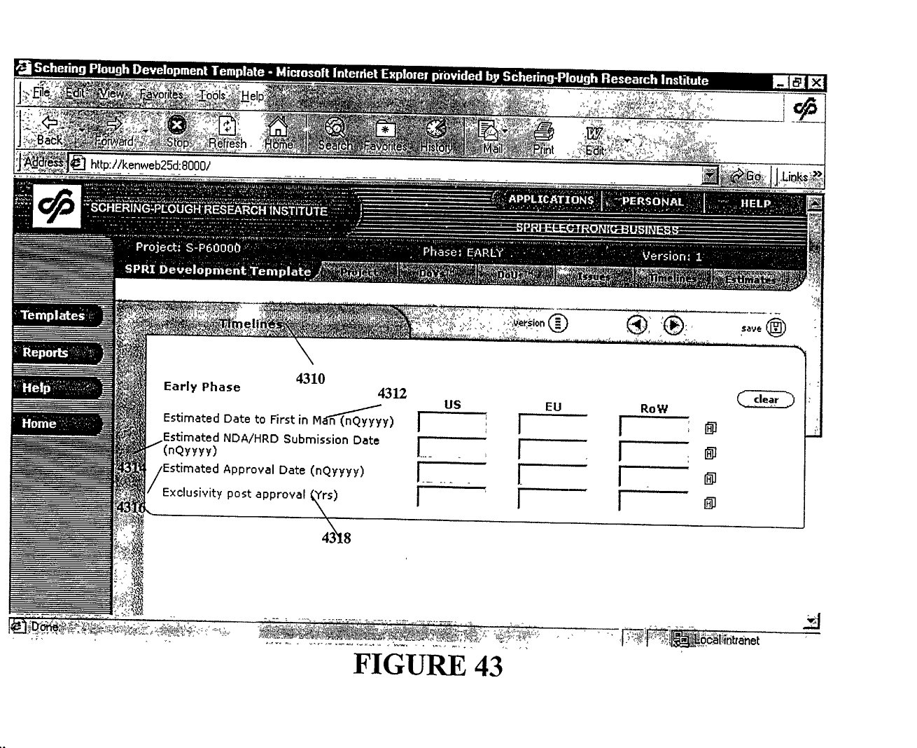

Turning to FIG. 38, which shows the second page of the Early Phase template, there is a “Key Timelines” section 3810 in which estimated dates are captured. A screen shot of the “Timelines” tab 4310 is shown in FIG. 43. The estimated date fields, which factor in those issues that may significantly affect launch time (e.g., requirement for additional toxicology studies, or new formulations) include “Estimated Date to First [Use] in Man” 4312, “Estimated NDA/HRD Submission Date” 4314 and “Estimated Approval Date” fields 4316 in each of the United States, European Union (“EU”) and the Rest of the World (“RoW”). These geographical area fields, may of course, be defined differently, depending on the requirements of the particular company using the system. (NDA stands for New Drug Application, and HRD is Health Registration Dossier, which is the European equivalent of the NDA.)

The “Expected Exclusivity Post Approval” field 3812, located in the section below the “Key Timelines” section, includes an estimate of how many years of protection the product will have in each of the above-mentioned locations. This is duplicated in field 4318 of the screen shot (FIG. 43). The “Exclusivity Issues” field 3812A captures information that can be related to patent issues (expiration/extension/infringement), data exclusivity or licensing agreements. The “Time Issues” field 3812B captures those issues that may significantly affect launch time, e.g., a requirement for an additional toxicology study or a new formulation.

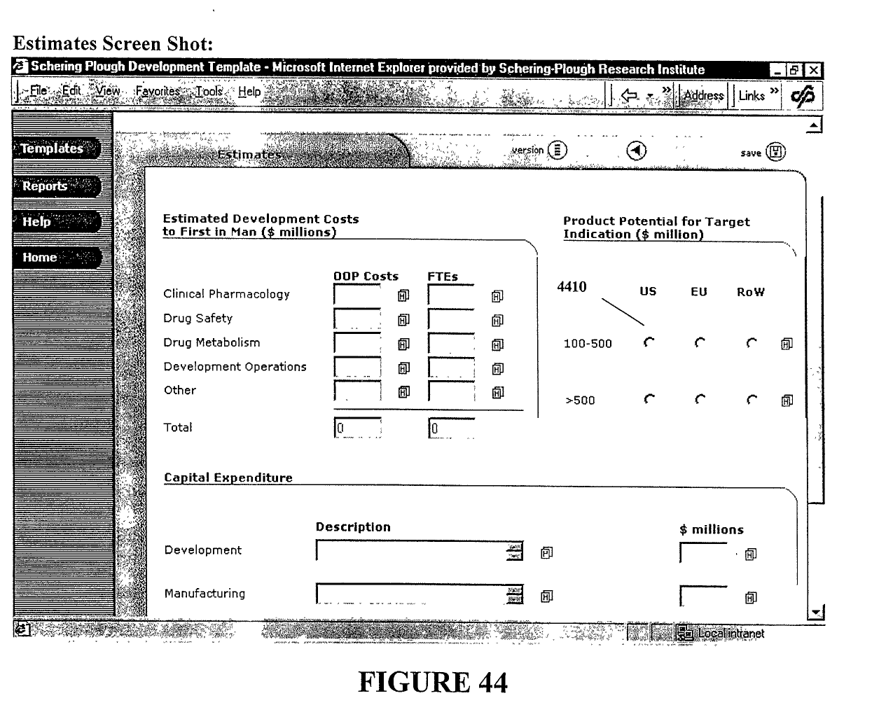

The “Estimated Development Costs to First in Man” section 3820 (FIG. 38) includes various discipline fields that capture both the cost estimates to First [Use] in Man as both “Out of Pocket (OOP) Costs” and “FTEs” (Full Time Equivalents) costs (in dollars, not man years) by discipline. These fields include “Clinical Pharmacology,” “Drug Safety,” “Drug Metabolism,” “Development Operations,” and “Other.” The “Total” refers to the sum of the costs relating to the various disciplines. A screen shot of the “Estimates” tab is shown in FIG. 44.

The “Product Potential” field 3830 (FIG. 38) captures abroad estimate ($100-500 million or greater than $500 million, in this example) of the potential market for the product in the United States, European Union (“EU”) and the Rest of the World (“RoW”). The information entered into these fields should be specific for the intended indication(s) in the current submission. Radio buttons may be used in place of the box fields as shown as 4410 in FIG. 44.

The “Estimated Gross Margin” field 3840 includes a value that may be based on any accepted estimated gross margin formula.

The “Capital Expenditure” portion 3850 of the template includes a “Development” and “Manufacturing” fields 3852, 3854, which are used as aids to planning. The information might include items such as building and equipping a new production facility. The “Assumptions Affecting Product Potential” field 3860 includes assumptions such as whether the desired price been estimated, whether the competition been assessed, whether the company is anticipated to be first to market, market size, and anticipated penetration.

### 6b. Late Phase Template

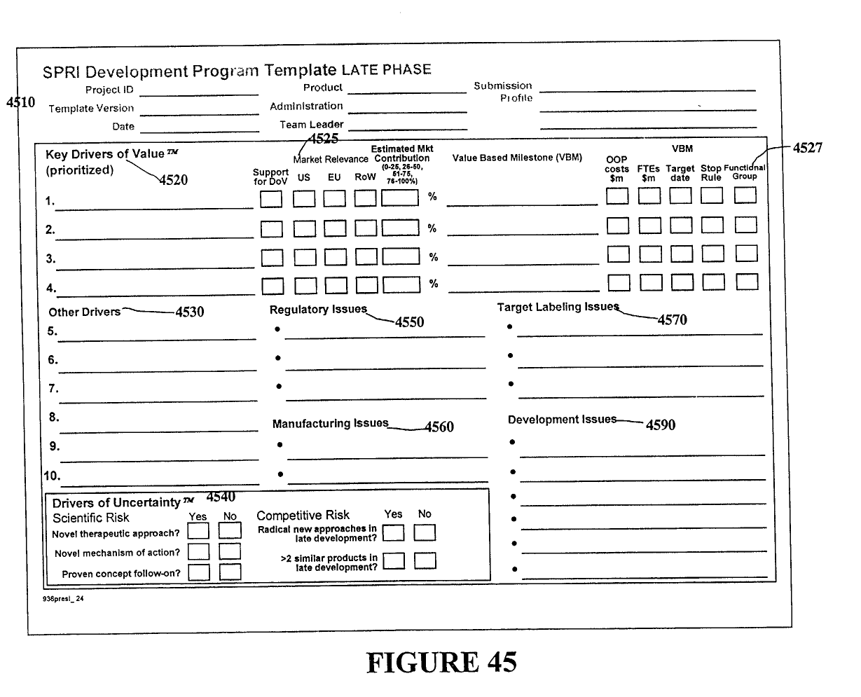

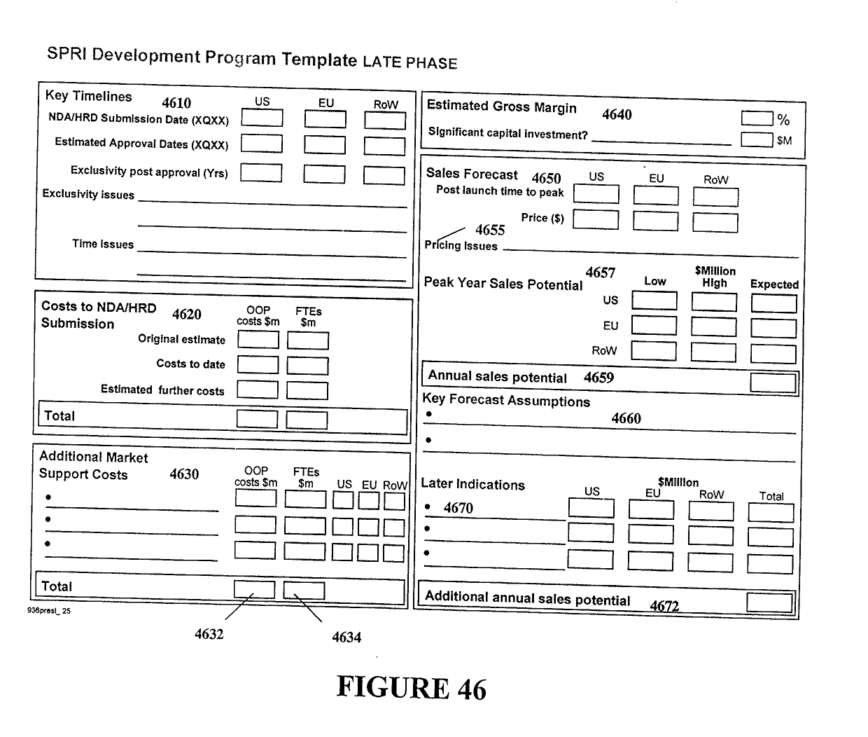

FIGS. 45 and 46 show the Late Phase template, which is designed to capture the dates and costs of achieving Value Based Milestones that provide information on key characteristics of the drug (Drivers of Value). The Late Phase template captures technical, regulatory, manufacturing, intellectual property, and commercial issues that could affect the market for the drug.

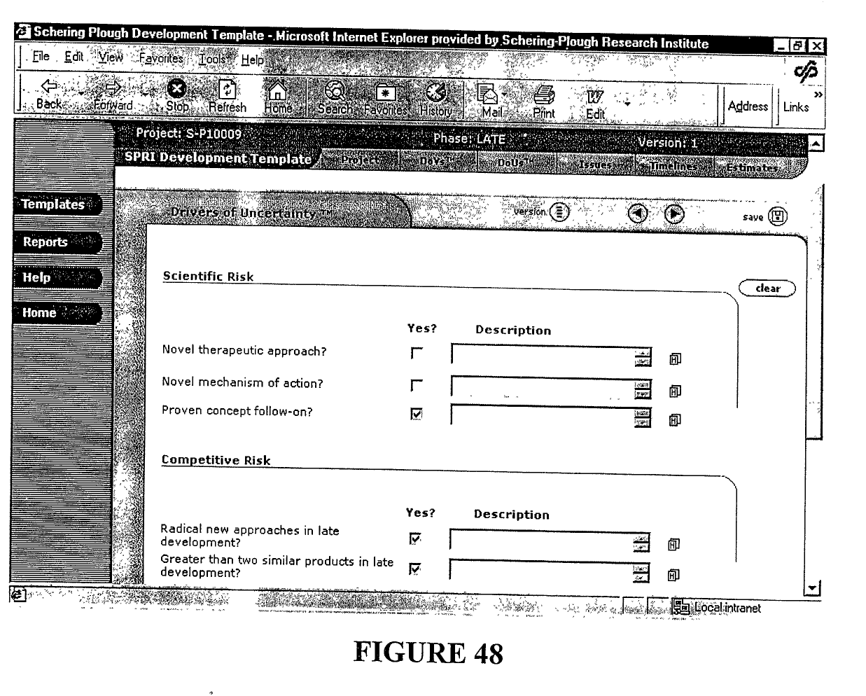

Some of the fields 4510 of the Late Phase template are the same as those of the Early Phase template described above. These fields include “Project ID,” “Template Version,” “Date,” “Product,” “Administration,” “Team Leader” and “Submission Profile.” The fields 4520 of te Late Phase template (FIG. 48) are the same as the “Key Drivers of Value,” “Support for Drivers of Value,” “Estimated Market Contribution,” “Value Based Milestones (VBM),” “OOP Costs,” “FTEs,” “Target Date,” “Stop Rule,” and “Functional Group,” which are shown in the screen shot of FIG. 37. The “Other Drivers” 4530 and “Drivers of Uncertainty” 4540 include “Scientific Risk” and “Competitive Risk” as in the screen shot of FIG. 37 for the Early Phase template. In these cases, the description of the Late Phase template field is the same as that for the Early Phase template field, and reference may be made to the Early Phase template description provided above.

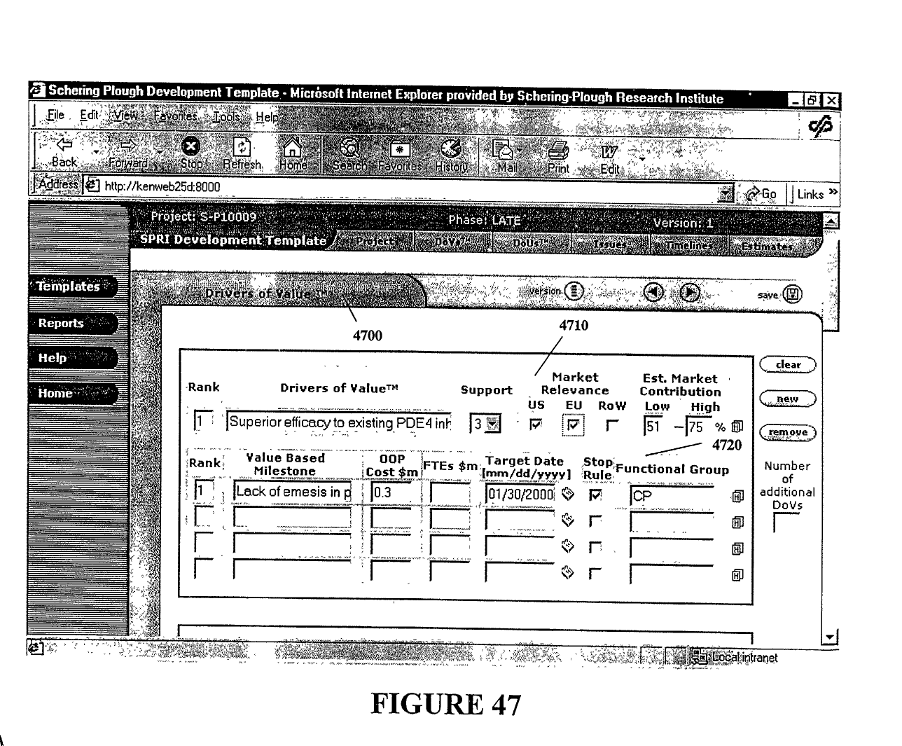

Referring to FIG. 45, which shows the first page of two of the Late Phase template, the “Market Relevance” field 4525 indicates the relevance of Key Drivers of Value in different markets, such as the US, European Union (EU) and Rest of the World (RoW). For example, if the Intron A patent expires in Europe before the US, the exclusivity in the EU would be different than in the US and the relative market effect would be different. The screen shot of the Drivers of Value tab 4700, which includes the market relevance fields 4710, is shown as FIG. 47.

The “Functional Group” field 4527, which is associated with the “Value Based Milestones (VBM)” section of the Late Phase template like that of the Early Phase template, captures the source area which is responsible for generating a particular Driver of Value. The source area may be, for example, Regulatory (RA), Clinical R&D (CR), US or Global Marketing (M) or Development Operations (DO). The screen shot of the Drivers of Value tab, which includes this field 4720, is shown as FIG. 47.

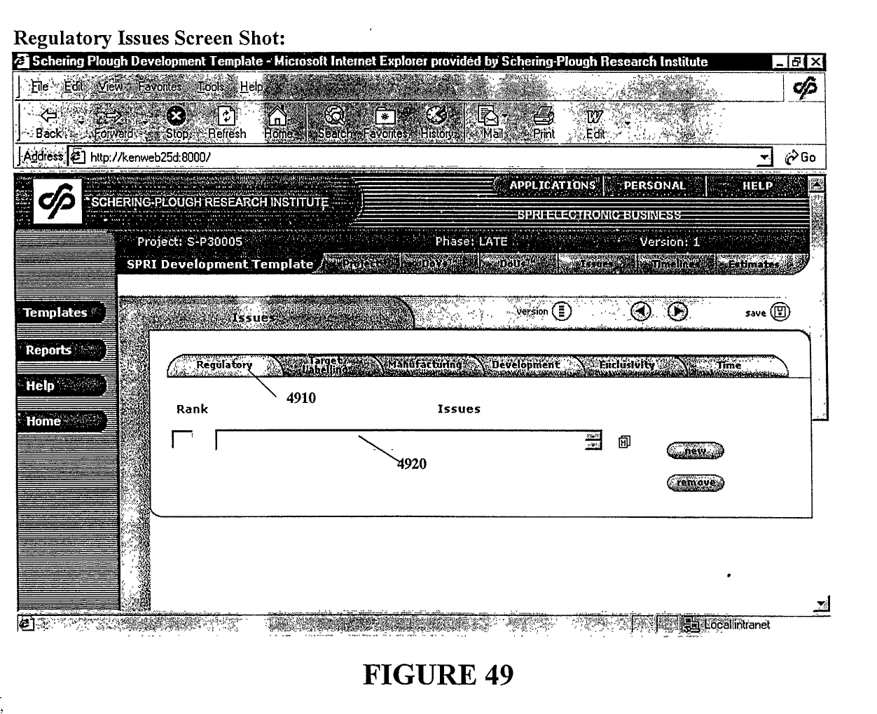

The “Regulatory Issues” field 4550 (FIG. 45) indicates whether there are any outstanding regulatory issues to be resolved. It is important to note that this is not a guess at the likelihood of getting approval. Rather, the issues may be whether the FDA has agreed to surrogate end-points, or whether the FDA might want additional studies. The screen shot of the Regulatory Issues tab 4910, which includes this field 4920, is shown as FIG. 49.

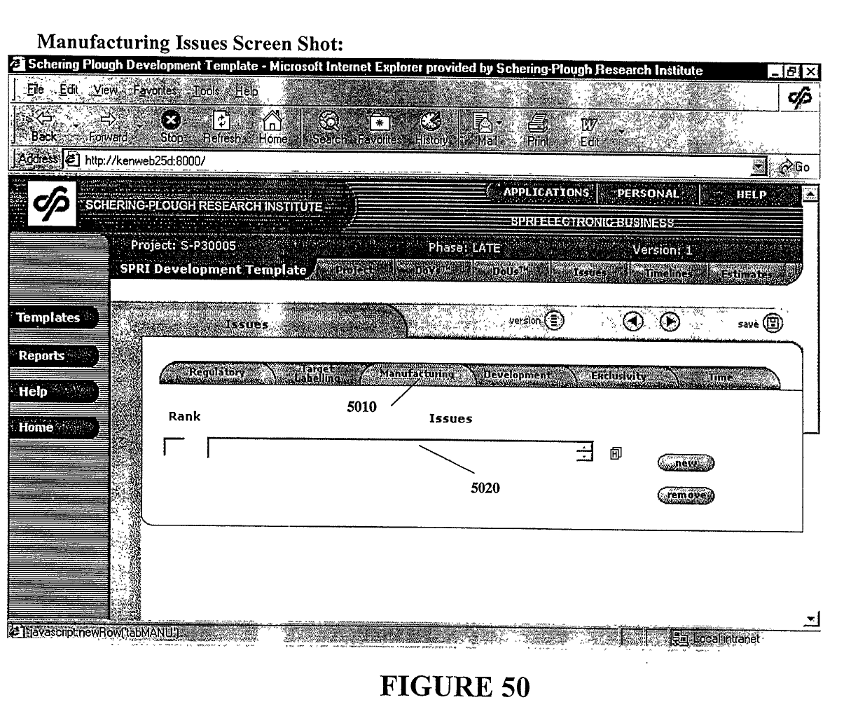

The “Manufacturing Issues” field 4560 (FIG. 45) should include any problematic or flagged area of manufacturing, such as process optimization, stability, or manufacturing capability to support clinical studies, that could be of concern and should be considered. The screen shot of the Manufacturing Issues tab 5010, which includes this field 5020, is shown as FIG. 50.

The “Target Labeling Issues” field 4570 captures any potential deviation from the desired labeling, alerting to possible erosion of the desired patient base. This field covers issues such as “do not use in pregnant women” versus “should not be used in women of childbearing age,” and multiple dosing regimens optimized for particular patient segments.

The “Development Issues” field 4580 includes key development issues, such as synthesis, formulation, combination therapy, abnormal toxicology, and drug interactions (e.g., Ziracin and aminoglycosides).

Referring now to FIG. 46, which shows the second page of the Late Phase template, the “Key Timelines” section 4610 captures estimated dates and related issues in much the same way as in the Early Phase template. The “NDA/HRD Submission Date” fields and the “Estimated Approval Dates” fields for the United States (US), European Union (EU) and Rest of the World (RoW) are self-explanatory. The “Exclusivity Post Approval” field is an estimate of how many years of protection the product will have in each of the US, EU and RoW. The “Exclusivity Issues” field can be related to patent issues (expiration/extension/infringement), data exclusivity or licensing agreements. The “Time Issues” field includes those time issues that may significantly affect product launch time, a requirement for an additional toxicology study, or a new formulation.

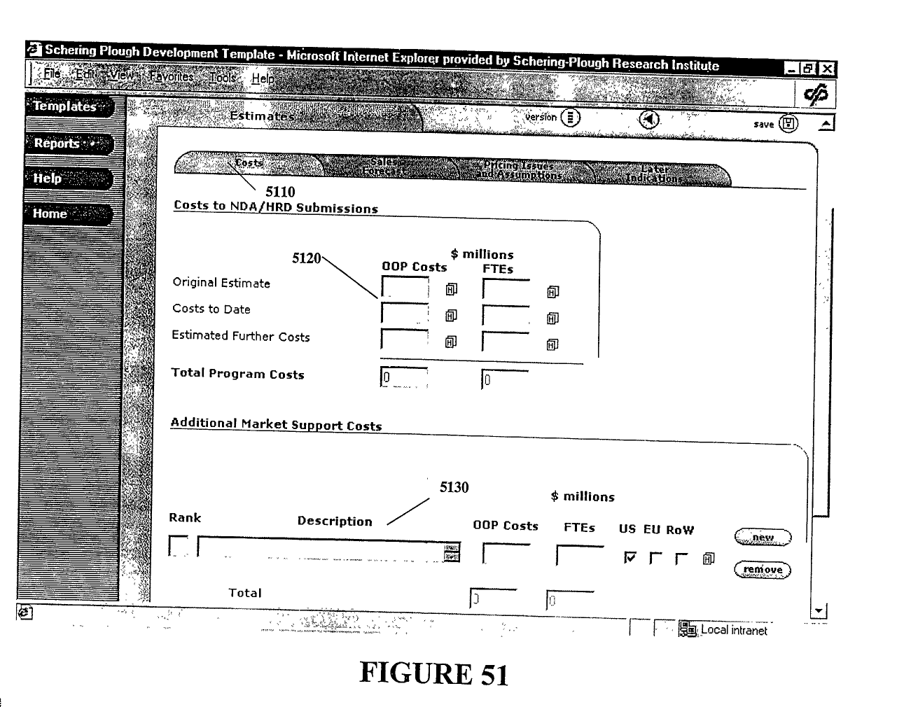

The “Costs to NDA/HRD Submission” section 4620 (FIG. 46) includes the “Original Estimate,” “Costs to Date” and “Estimated Further Costs” fields, which are all captured as both Out Of Pocket (OOP) costs and Full Time Equivalents (FTE) costs (in dollars, not man years). The original estimate may be compared to the actual and remaining costs to monitor both progression of the project and unanticipated changes in the budget. These figures will indicate whether there is satisfactory financial control of the project, and whether an additional Phase III trial might be required. The “Total” field includes the sum of the costs to date and any further costs up to NDA submission. The screen shot of the Costs Estimates tab 5110, which includes these fields 5120, is shown as FIG. 51.

The “Additional Market Support Costs” section 4630 (FIG. 46) includes costs that must be incurred to ensure a successful product. These market support activities should be evaluated on the basis of Out Of Pocket (OOP) costs, Full Time Equivalent (FTE) costs, and an indication of the geographical area (US, EU or RoW) for which the market support is most relevant. Examples of additional costs are costs associated with investigator initiated studies, and additional marketing studies. The two “Total” fields 4632, 4634 represent the respective sums of the OOP costs and the FTE costs. This field is also included in the Cost Estimates tab 5110, shown as FIG. 51, in section 5130.

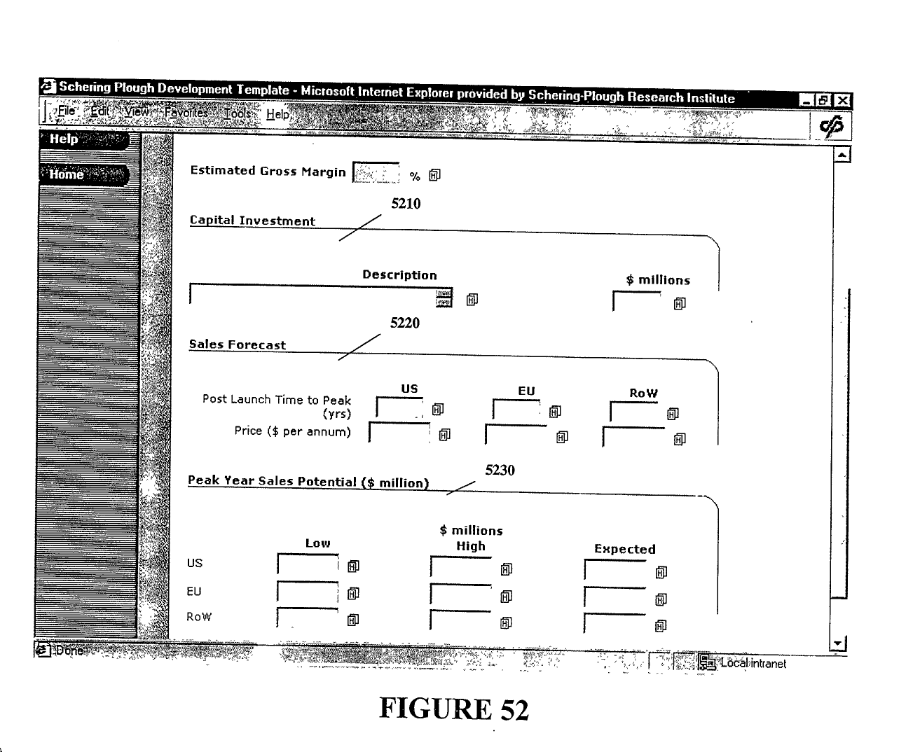

The “Estimated Gross Margin” section 4640 (FIG. 46) includes a “Significant Capital Investment” field, which is used as an aid in planning. The dollar value in this field might include the costs associated with items such as building and equipping a new production facility. The screen shot of the Sales Forecasts Estimates tab, which includes this field 5210, is shown as FIG. 52.

The “Sales Forecast” section 4640 (FIG. 46) includes a “Post Launch Time to Peak” and “Price” fields, which capture the price per year to attain peak sales, in each of the US, EU and RoW markets. The peak may vary in different markets in a predictable fashion, as in uptake rates of new technology, but is usually around the fifth year. This section will give an estimate of the time for return on investment. This field 5220 is also included in the Sales Forecasts Estimates tab, shown as FIG. 52.

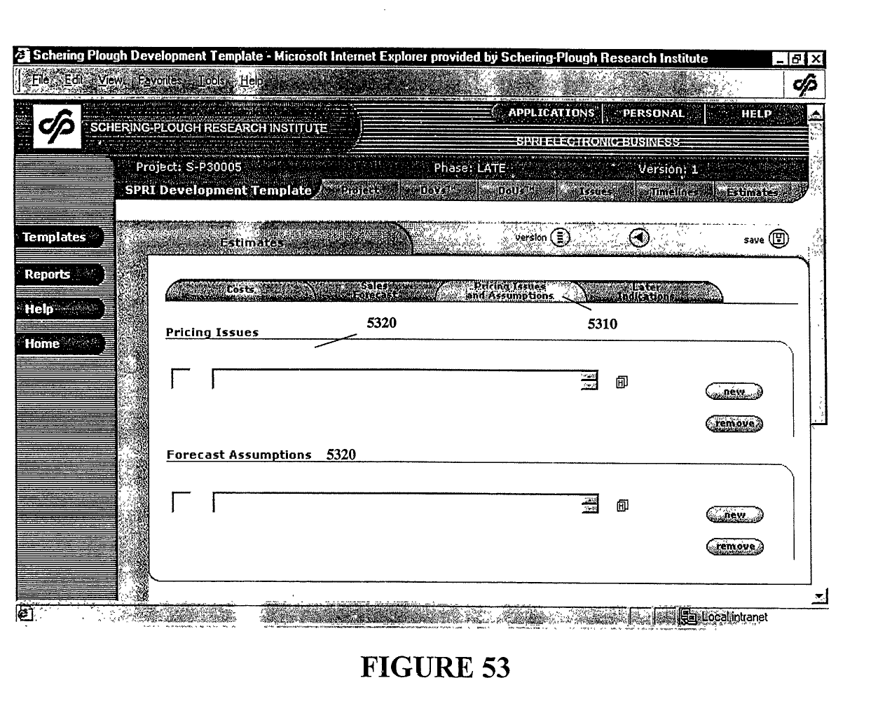

The “Pricing Issues” field 4655 (FIG. 46) captures a numeric rank and atextual explanation of any issues related to the pricing of the product. The field indicates whether the desired price has been estimated, whether any other pricing factors have to be taken into account, and whether there is a premium price already in existence for another indication (e.g., HCV) that could not be justified for the current template indication (e.g., HIV). The screen shot of the Pricing Issues and Assumptions Estimates tab 5310, which includes this field 5320, is shown as FIG. 53.

The “Peak Year Sales Potential” section 4657 (FIG. 46) captures the range (low and high) and (expected sales potential for each of the United States, European Union and the Rest of World markets. The “Annual Sales Potential” field 4659 represents the sum of the expected value for each of the geographical markets. This field 5230 is also included in the Sales Forecasts Estimates tab, shown as FIG. 52.

The “Key Forecast Assumptions” field 4660 (FIG. 46) captures the assumptions made to arrive at the Sales Forecast described above. These assumptions are ultimately accessed through a drill down (i.e., detailed analysis of supporting documents and assumptions), and should be regularly revisited to make sure that their validity has not been eroded by competition or changes in the product profile itself. It is useful to annotate source document to indicate who entered data and why changes in data were made This field 5320 is also included in the Pricing Issues and Assumptions Estimates tab 5310, shown as FIG. 53.

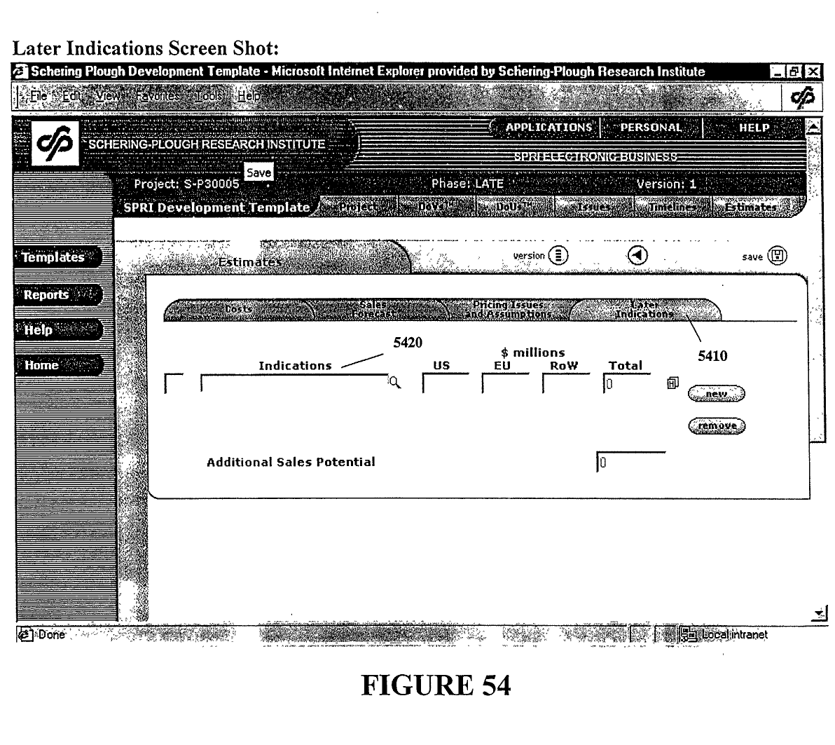

The “Later Indications” field 4670(Fig. 46) captures the additive effect of later indications on the total annual sales potential in each of the US, EU and RoW markets. The “Total” fields represent the sum of the values for each of the geographical markets. Finally, the “Additional Annual Sales Potential” field 4672 represents the sum of the “Total” fields for each of the geographical markets in the “Later Indications” field. The screen shot of the Later Indications Estimates tab 5410, which includes this field 5420, is shown as FIG. 54.

While the present invention has been particularly shown and described with reference to a preferred embodiment thereof, it will be understood by those skilled in the art that various changes in form and details may be made therein without departing from the spirit and scope of the invention.

We claim:

1. A method of evaluating a regulatory submission project for seeking approval of the sale of an item, comprising:
establishing in a computer a set of templates defining milestones and times based on qualitative assessments of the item;
establishing a relative quantitative value of completing a milestone;
entering information into a database about past and ongoing evaluations of the item, including tests performed on the item;
determining whether a milestone has been achieved on time;
if a milestone has not been achieved on time, calculating the relative loss in value to the sales of the item based on the relative quantitative value of completing the milestone; and
reporting the status of the evaluation.

2. The method of claim 1, wherein the milestones include stop rules, which indicate whether the project should be stopped if a milestone is not achieved.

3. The method of claim 2, wherein the stop rule is a decision to either not proceed with the project or to stop the project temporarily.

4. The method of claim 1, wherein each milestone is associated with a respective success factor, and the success factors are prioritized according to potential impact on sales.

5. The method of claim 1, wherein at least one template is an early phase template designed to capture data up to a first use with a human being.

6. The method of claim 1, wherein at least one template is a late phase template designed to capture data subsequent to a first use with a human being.

7. The method of claim 1, wherein multiple level of access rights are used to control, based in a user's role, a level of user access to the system.

8. A system for evaluating a regulatory submission project for seeking approval of the sale of an item, comprising:
a computer system in which a set of templates is stored, said templates defining milestones and times based on qualitative assessments of the item, said computer system having stored therein a relative quantitative value of completing a milestone;
a database of information associated with said computer system, said database having information about past and ongoing evaluations of the item, including tests performed on the item;
at least one user terminal connected to the computer system and capable of querying the system as to whether a milestone has been achieved on time, if a milestone has not been achieved on time, said user terminal causing said computer system to calculate the relative loss in value to sales of the item based on the relative quantitative value of completing the milestone, said user terminal further causing said computer system to report the status of the evaluation.

9. The system of claim 8, wherein the milestones include stop rules, which indicate whether the project should be stopped if a milestone is not achieved.

10. The system of claim 9, wherein the stop rules are decisions to either not proceed with the project or to stop the project temporarily.

11. The system of claim 8, wherein each milestone is associated with a respective success factor, and the success factors are prioritized according to potential impact on sales.

12. The system of claim 8, wherein at least one template is an early phase template designed to capture data up to a first use with a human being.

13. The system of claim 8, wherein at least one template is a late phase template designed to capture data subsequent to a first use with a human being.

14. The system of claim 8, wherein the system is browser-based.

15. The system of claim 8, further comprising multiple levels of access rights for controlling, based in a user's role, a level of access by a user to the system.

16. A method of evaluating a regulatory submission project for seeking approval of the sale of an item, comprising:
establishing a set of success factors that have a potential impact on sales of the item;
establishing in a computer a template defining milestones, which are associated with the success factors, based on qualitative assessments of the item;
establishing a relative quantitative value of completing a milestone;
entering into a database information about evaluations of the item, including tests performed on the item;
determining whether a milestone has been achieved on time;
if a milestone has not been achieved on time, calculating the relative loss in value to the sales of the item based on the relative quantitative value of completing the milestone; and
reporting the status of the evaluation.

17. The method of claim 16, wherein the success factors are prioritized by size of potential impact on sales of the item.

18. The method of claim 16, wherein the template includes for each of success factor an estimated market contribution.

19. The method of claim 16, wherein the template includes costs to achieve each milestone.

20. The method of claim 16, wherein the template includes a date at which a milestone will be achieved.

21. The method of claim 16, wherein the template includes a stop rule that indicates whether the project will be stopped if a success factor is not achieved.

22. The method of claim 16, wherein the success factors include key success factors that are critical to market success or failure of the item.

23. The method of claim 16, wherein the template includes data indicating a likelihood that a success factor will be achieved.

24. The method of claim 16, wherein the template is an early phase template and includes technical issues to be resolved.

25. The method of claim 16, wherein the template includes factors of uncertainty.

26. The method of claim 16, wherein the template includes a timelines of estimated dates which factor in issues that may significantly affect launch time of the item.

27. The method of claim 16, in which the template is an early phase template including an estimate of years of protection the item will have in a particular geographic area.

28. The method of claim 16, wherein the template is an early phase template including estimated development costs.

29. The method of claim 16, wherein the template is an early phase template including an estimated market potential of the item.

30. The method of claim 16, wherein the template is an early phase template including estimated gross margin.

31. The method of claim 16, wherein the template is an early phase template including capital expenditures.

32. The method of claim 16, wherein the template is a late phase template including outstanding regulatory issues to be resolved.

33. The method of claim 16, wherein the template is a late phase template including problematic manufacturing issues.

34. The method of claim 16, wherein the template is a late phase template including potential deviations form desired labeling of the item.

35. The method of claim 16, wherein the template is a late phase template including a forecast of post launch time to peak sales.

36. The method of claim 16, wherein the template is a late phase template including pricing issues of the item.

37. The method of claim 16, wherein the template is a late phase template including peak year sales potential.

38. A system for evaluating a regulatory submission project for seeking approval of the sale of an item, comprising:
a quantified set of success factors that have a potential impact on sales of the item;
a computer system in which a set of templates is stored, said templates defining milestones which are associated with the success factors, based on qualitative assessments of the item, said computer system having stored therein a relative quantitative value of completing a milestone;
a database of information associated with said computer system, said database having information about evaluations of the item, including tests performed on the item;
at least one user terminal connected to the computer system and capable of querying the system as to whether a milestone has been achieved on time, and if a milestone has not been achieved on time, said user terminal causing said computer system to calculate the relative loss in value to sales of the item based on the relative quantitative value of completing the milestone, said user terminal further causing said computer system to report the status of the evaluation.

39. The system of claim 3 8, wherein the success factors are prioritized by size of potential impact on sales of the item.

40. The system of claim 38, wherein the template includes for each of success factor an estimated market contribution.

41. The system of claim 38, wherein the template includes costs to achieve each milestone.

42. The system of claim 3 8, wherein the template includes a date at which a milestone will be achieved.

43. The system of claim 38, wherein the template includes a stop rule that indicates whether the project will be stopped if a success factor is not achieved.

44. The system of claim 3 8, wherein the success factors include key success factors that are critical to market success or failure of the item.

45. The system of claim 38, wherein the template includes data indicating a likelihood that a success factor will be achieved.

46. The system of claim 38, wherein the template is an early phase template and includes technical issues to be resolved.

47. The system of claim 38, wherein the template includes factors of uncertainty.

48. The system of claim 38, wherein the template includes a timeline of estimated dates which factor in issues that may significantly affect launch time of the item.

49. The system of claim 38, in which the template is an early phase template including an estimate of years of protection the item will have in a particular geographic area.

50. The system of claim 38, wherein the template is an early phase template including estimated development costs.

51. The system of claim 38, wherein the template is an early phase template including an estimated market potential of the item.

52. The system of claim 38, wherein the template is an early phase template including estimated gross margin.

53. The system of claim 38, wherein the template is an early phase template including capital expenditures.

54. The system of claim 38, wherein the template is a late phase template including outstanding regulatory issues to be resolved.

55. The system of claim 38, wherein the template is a late phase template including problematic manufacturing issues.

56. The system of claim 38, wherein the template is a late phase template including potential deviations form desired labeling of the item.

57. The system of claim 38, wherein the template is a late phase template including a forecast of post launch time to peak sales.

58. The system of claim 38, wherein the template is a late phase template including pricing issues of the item.

59. The system of claim 38, wherein the template is a late phase template including peak year sales potential.
